(19) United States
(12) Patent Application Publication
(10) Pub. No.: US 2026/0058155 A1
(43) Pub. Date: Feb. 26, 2026

(54) SECONDARY BATTERY ELECTRODE, SECONDARY BATTERY, AND PRODUCTION METHOD THEREFOR

(71) Applicant: NATIONAL UNIVERSITY CORPORATION YAMAGATA UNIVERSITY, Yamagata-shi, Yamagata (JP)

(72) Inventors: Manabu ISHIZAKI, Yamagata-shi (JP); Masato KURIHARA, Yamagata-shi (JP)

(73) Assignee: NATIONAL UNIVERSITY CORPORATION YAMAGATA UNIVERSITY, Yamagata-shi, Yamagata (JP)

(21) Appl. No.: 19/105,637

(22) PCT Filed: Aug. 25, 2022
(86) PCT No.: PCT/JP2022/032132

§ 371 Date: Feb. 21, 2025

(51) Int. Cl. H01M 4/62; C01C 3/12; H01M 4/131; H01M 4/66; H01M 4/80; H01M 10/052

(52) U.S. Cl. CPC H01M 4/625; C01C 3/12; H01M 4/131; H01M 4/663; H01M 4/806; H01M 10/052; C01P 2004/03; C01P 2004/52; C01P 2006/40

(57) ABSTRACT

An electrode for a secondary battery, including carbon nanotubes and active material particles having an average particle size of 2 to 1000 nm supported in a state of being dispersed in the carbon nanotubes, wherein a mass ratio of the carbon nanotubes to a total mass of the active material particles and the carbon nanotubes is 0.1 wt % or more.

### FIELD

The present invention relates to an electrode for a secondary battery, a secondary battery, and a method for producing the same.

### BACKGROUND

In order to achieve SDGs, there is a need for innovations in the storage and utilization of electrical energy converted from various natural energies. Among them, as shown in the Ragone Plot, ion secondary batteries in which a high energy density is an advantage and supercapacitors in which an output (power) density due to fast charging and discharging is an advantage are attracting attention.

In the development of ion secondary batteries, it is necessary not only to further improve the energy density but also to improve the high-speed charge-discharge characteristics. In the development of supercapacitors, it is necessary to further improve the energy density, and there is a problem including safety due to large voltage fluctuation during charging and discharging.

Therefore, at present, the ion secondary battery and the super capacitor are used in a limited manner depending on the application, and in some cases, it is also studied to use both in a combined manner.

In addition to small mobile devices such as mobile phones and lightweight notebook computers, Li-ion secondary batteries, which are also installed in electric vehicles that consume a large amount of electric power, need to be repeatedly charged and discharged at a low speed of about 1 C or less in order to utilize all of the battery capacity.

In this regard, according to Non-Patent Literature 1, taking electric vehicles as an example, the construction of Li-ion secondary batteries that can maintain their original battery capacity at 100 C under the C-rate standard, in other words, batteries that can be charged and discharged at ultra-high speeds, is introduced as an achievement target, and data is disclosed showing that the discharge capacity of 54% was maintained at 100 C.

Non-Patent Literature 2 discloses the performance of Prussian blue analogues (PBA) composed of five different metal ions (Mn, Fe, Co, Ni, Cu), so-called Na-ion secondary batteries using high-entropy crystals as a positive electrode. In high-entropy PBA crystals with a cubic shape and an average particle size of 1 μm, the strain caused by the lattice size change in the de-insertion and insertion of Na⁺ is reduced, and the repetitive durability is improved. Further, for example, it is disclosed that, even when charging and discharging are performed at 8 C, 68% of the discharge capacity at low speed is maintained, and a decrease in the capacity at high speed charging and discharging is suppressed.

Non-Patent Literature 3 discloses that a cubic-shaped Prussian blue (PB) having a thickness of 500 nm to 1.5 μm is crystal-grown on carbon black to achieve an effect of suppressing aggregation between PB crystal particles, and to improve the high-speed charging and discharging performance of a Na ion secondary battery using an electrode formed by mixing with an organic binder, and for example, it is disclosed that 67% of the discharge capacity at low speed is maintained at 90 C.

Non-Patent Literature 4 discloses that the aggregation of PB crystals is suppressed by depositing PB crystals having various shapes and particle sizes on mesoporous carbon. In addition to the surface-etched PB having a cubic shape of several μm, PB having a small particle diameter of 100 to 200 nm is mixed to increase the surface area, thereby improving the high-rate charge and discharge performance of the Na-ion secondary battery. The high conductivity of mesoporous carbon and the presence of a fast migration path of Na by myriad pores have been shown to retain 75%, at 28 C, of the discharging capacity at low speed.

Non-Patent Literature 5 discloses growing cubic PB having a particle size of 400 to 600 nm in an isolated state on multi-walled carbon nanotube (MWNT) fibers. It has been shown to improve the high-speed charge-discharge performance of the Na-ion secondary battery under a low-temperature environment, and to retain 76%, at 6 C at a room temperature of 25° C., of the discharge capacity at low speed.

Non-Patent Literature 6 discloses that aggregated PB nanoparticles are deposited on a bundled single-walled carbon nanotube (SWNT) surface to produce a free-standing electrode free of an organic binder. It has been shown to improve the high-speed charge-discharge performance of Li-ion secondary batteries in a low-temperature environment, and to retain 48%, at 3 C at room temperature, of the discharge capacity at the low-rate.

Non-Patent Literature 7 discloses that PBA nanoparticles made of Mn and Fe having an average particle diameter of 300 nm, carbon nanotubes (CNTs), and carbon nanofibers (CNFs) are suspended in a mixed solvent of ethanol and water by sonication, and the suspension is filtered to produce a binder-free self-supporting membrane. Scanning electron micrographs of the self-supporting film show that CNT/CNF and PBA nanoparticles are entangled unevenly, with many areas where only aggregated PBA nanoparticles are densely packed and areas where only CNTs/CNFs are densely packed being observed. It is further demonstrated that 79% of the discharge capacity at the low-rate is retained at 20 C.

Non-Patent Literature 8 discloses that FeOOH nanorods and SWNTs are sonicated together with a surfactant and suspended in water, and the filter membrane is transferred to a copper foil, which is heated at 450° C. to convert the FeOOH into Fe₃O₄. Scanning electron micrographs show that the agglomerated Fe₃O₄ nanorods are entangled in the SWNTs and 60% of the discharging capacity at low speed is retained at 10 C as Li-ion secondary batteries.

Non-Patent Literature 9 discloses a positive electrode produced by kneading PBA nanoparticles made of Zn and Fe having an average particle diameter of 150 nm with acetylene black (conductive auxiliary agent) and polyvinyl fluoride (binder) by a conventional electrode production method. It has been shown that 61% of the discharge capacity at low speed is retained at 65 C in a Zn-ion secondary battery.

Non-Patent Literature 10 discloses a positive electrode produced by kneading PBA made of Cu and Fe of 20 to 50 nm with amorphous carbon and graphite (conductive auxiliary agent) and polyvinyl fluoride (binder) by a conventional electrode production method. It has been shown that the positive electrode performance associated with the de-insertion and insertion of K′ ions in three-electrode system using a referencing electrode rather than a battery construction, retains 68%, at 83 C, of the discharging capacity at low speed.

Non-Patent Literature 11 discloses a positive electrode produced by kneading PBA nanoparticles made of Mn and Fe of 50 to 200 nm with acetylene black (conductive auxiliary agent) and polyvinyl fluoride (binder) by a conventional electrode production method. It has been shown that, as a K-ion secondary battery, 54% of the discharge capacity at low speed is retained at 4 C.

### CITATION LIST

### Non-Patent Literature

[NPL 1] Development of high-speed charge-discharge rechargeable lithium-ion battery, FB technical news 64 (2008,11)
[NPL 2] Advanced Functional Materials, 32, 2202372 (2022)
[NPL 3] Advanced Functional Materials, 26, 5315-5321 (2016)
[NPL 4] ACS Applied Materials & Interfaces, 13, 38202-38212 (2021)
[NPL 5] Advanced Materials, 28, 7234-7248 (2016)
[NPL 6] Nanoscale Advances, 4, 510-520 (2022)
[NPL 7] Small, 15, 1902420 (2019)
[NPL 8] Advanced Energy Materials, 22, E145-E149 (2010)
[NPL 9] Energy Storage Materials, 42, 715-722 (2021)
[NPL 10] Nature Communications, 2, 550 (2011)
[NPL 11] Nature Communications, 12, 2167 (2021)

### SUMMARY

### Technical Problem

However, in Non-Patent Literatures 1 to 11 described above, the high-speed charge-discharge performance is not yet sufficient, and there is a demand for an electrode for a secondary battery capable of achieving both high energy density, which is a characteristic of an ion secondary battery, and excellent high-speed charge-discharge characteristics.

### Solution to Problem

The gist of the present invention is as follows.
(1) An electrode for a secondary battery, comprising
   carbon nanotubes, and
   active material particles having an average particle size of 2 to 1000 nm supported in a state of being dispersed in the carbon nanotubes,
   wherein a mass ratio of the carbon nanotubes to a total mass of the active material particles and the carbon nanotubes is 0.1 wt % or more.
(2) The electrode according to (1) above, wherein a ratio of a number of primary particles to a number of all particles of the active material particles is 70% or more.
(3) The electrode according to (1) or (2) above, wherein the electrode does not comprise a binder.
(4) The electrode according to any one of (1) to (3) above, wherein the active material is Prussian blue or an analog thereof.
(5) The electrode according to (4) above, wherein the Prussian blue or an analog thereof is Fe—Zn Prussian blue or an analog thereof, Zn—Mn Prussian blue or an analog thereof, or Fe—Cu Prussian blue or an analog thereof.
(6) A secondary battery comprising the electrode according to any one of (1) to (5) above, a counter electrode, an electrolyte solution, and a current collector.
(7) The secondary battery according to (6) above, wherein the concentration of the electrolyte solution is 0.8 M or more.
(8) The secondary battery according to (6) or (7) above, wherein the current collector is carbon paper.
(9) The secondary battery according to any one of (6) to (8) above, wherein the secondary battery has an energy density of 60 Wh/kg or more and a power density of 30000 W/kg or more.
(10) The secondary battery according to any one of (6) to (8) above, wherein a capacity retention ratio with respect to a capacity at 1 C when an energy density of 60 Wh/kg or more and a power density of 10000 W/kg or more are obtained is 80% or more.
(11) The secondary battery according to any one of (6) to (8) above, wherein a capacity retention ratio with respect to a capacity at 1 C when an energy density of more than 100 Wh/kg and a power density of 10000 W/kg or more are obtained is 60% or more.
(12) A method for producing an electrode for a secondary battery, comprising:
   surface-modifying active material particles having an average particle size of 2 to 1000 nm to prepare a dispersion liquid of the active material particles in which the surface-modified active material particles are dispersed;
   preparing a dispersion liquid of carbon nanotubes;
   mixing the dispersion liquid of the active material particles and the dispersion liquid of the carbon nanotubes so that a mass ratio of the carbon nanotubes to a total mass of the active material particles and the carbon nanotubes is 0.1 wt % or more to form a mixed liquid; and
   applying the mixed liquid onto a substrate to obtain an electrode film.
(13) The method for producing an electrode for a secondary battery according to (12) above, wherein the applying the mixed liquid onto the substrate to obtain the electrode film comprises filtering the mixed liquid through a filter to obtain a filtration membrane.
(14) The method according to (12) or (13) above, wherein the filter is a polytetrafluoroethylene membrane.

### Advantageous Effects of Invention

According to the present invention, it is possible to provide an electrode for a secondary battery capable of achieving an excellent balance between high energy density and high-speed charge and discharge characteristics.

### BRIEF DESCRIPTION OF DRAWINGS

FIG. 1 is a particle size distribution of active materials in dispersion liquids of the active material prepared in the Example and the Comparative Example.

FIG. 2 is a schematic diagram of a configuration of a battery used for charge and discharge evaluation.

FIG. 3 is an example of the discharge curve for explaining how to calculate the numerical value of the Ragone plot.

FIG. 4 is a scanning electron microscope image of a binder-free electrode including different amounts of single-walled carbon nanotubes prepared in the Examples.

FIG. 5 is a graph showing the relationship of capacity to C-rate of a secondary battery produced using a binder-free electrode including different amounts of single-walled carbon nanotubes prepared in the Examples.

FIG. 6 is a graph showing the relationship between the C-rate and the battery capacity according to the concentration of the electrolyte solution of the secondary battery produced in the Examples.

FIG. 7 is a scanning electron microscope image of electrodes having different active material loadings prepared in the Examples.

FIG. 8 is a graph showing the charge and discharge characteristics of the secondary battery produced in the Examples and the C-rate characteristics of the secondary battery having different active material loading amounts.

FIG. 9 is a graph showing a change in capacity according to the number of times of charging and discharging of the secondary battery produced in the Example.

FIG. 10 is a scanning electron microscope image of a binder-free electrode prepared in the Example.

FIG. 11 is a graph showing the charge-discharge curve and C-rate characteristics of a secondary battery including the binder-free electrode prepared in the Example.

FIG. 12 is a graph showing charge-discharge characteristics of a secondary battery produced by using the binder-free electrode and the aqueous electrolyte prepared in the Example.

FIG. 13 is a graph showing the charge-discharge curve and C-rate characteristics of a secondary battery including the binder-free electrode prepared in the Example.

FIG. 14 is a scanning electron microscope image of (a) a binder-containing electrode prepared in the Comparative Example and (b) a binder-free electrode prepared using an active material suspension in the Comparative Example.

FIG. 15 is an example of a graph for explaining how to calculate the slope of the plateau region from the differential curve of the discharge curve.

FIG. 16 is a graph showing C-rate characteristics of (a) a secondary battery produced using a binder-containing electrode of the Comparative Example, (b) a secondary battery including a binder-free electrode prepared using an active material suspension of the Comparative Example, and (c) a secondary battery produced in the Example.

FIG. 17 is a Ragone plot showing the relationship between the energy density (capacity) and the power (output) density of the secondary batteries prepared in the Examples and the Comparative Examples.

FIG. 18 is a Ragone plot in which the horizontal axis representing the relationship between the energy density (capacity) and the power (output) density of the secondary batteries produced in the Examples and the Comparative Examples is a real number display.

FIG. 19 is a scanning electron microscope image obtained by observing the electrode produced in the Example from the surface.

FIG. 20 is a scanning electron microscope image obtained by observing the electrode produced in the Comparative Example from the surface.

FIG. 21 is a scanning electron microscope image obtained by observing electrodes having different loadings produced in the Examples from the cross section.

FIG. 22 is a graph showing C-rate characteristics of (a) a secondary battery produced using a binder-containing electrode of the Comparative Example, (b) a secondary battery including a binder-free electrode prepared using an active material suspension of the Comparative Example, and (c) a secondary battery produced in the Example.

### DESCRIPTION OF EMBODIMENTS

The present disclosure is directed to an electrode for a secondary battery, comprising carbon nanotubes and active material particles having an average particle size of 2 to 1000 nm supported in a state of being dispersed in the carbon nanotubes, wherein a mass ratio of the carbon nanotubes to a total mass of the active material particles and the carbon nanotubes is 0.1 wt % or more. In the present application, the secondary battery means an ion secondary battery.

The electrode of the present disclosure can provide an electrode for a secondary battery capable of achieving an excellent balance between high energy density and high-speed charge and discharge characteristics. Specifically, the electrode of the present disclosure can achieve an excellent balance between high energy density and high-speed charge and discharge characteristics as compared with an electrode prepared by a conventional process. The conventional process refers specifically to a suspension process, and the suspension process refers to a process of mechanically mixing a dispersion liquid of an active material and a dispersion liquid of a conductive auxiliary agent, such as ultrasonic cleaning. The method described in Non-Patent Literature 7 is a suspension process, in which active material particles are mixed with a carbon nanotube dispersion liquid, and the mixture is stirred while performing ultrasonic treatment to prepare an electrode. In addition, the electrode of the present disclosure is capable of achieving an excellent balance between high energy density and high-speed charge and discharge characteristics as compared with a conventional binder-containing electrode. The conventional binder-containing electrode refers to an electrode including a binder in addition to an active material and a conductive auxiliary agent in order to form the electrode.

The electrode for a secondary battery of the present disclosure (hereinafter, also referred to as the electrode) comprises active material nanoparticles which are dispersed in the carbon nanotubes functioning as conductive auxiliary agents and has a high mass ratio (high density) with respect to the mass of the carbon nanotubes, in an electrode matrix composed of the carbon nanotubes and the active material particles. In addition, the electrode can retain an electrode structure including the active material nanoparticles dispersed in the carbon nanotubes without requiring an organic binder. The electrode is an unprecedented excellent electrode for a secondary battery in which the active material particles are well dispersed, the content of the carbon nanotubes which are conductive auxiliary agents may be small, and a binder is not required. This enables the formation of a porous electrode matrix, ensuring excellent contact between the electrolyte solution and active material particles, and allowing the electrode to fully exhibit its function.

The electrode may have a structure in which the active material particles are well dispersed and bridged with the carbon nanotubes. Since the electrode includes the active material nanoparticles having a high mass ratio (high density) dispersed in the carbon nanotubes without requiring a binder, the mass ratio of the active material and the conductive auxiliary agent in the electrode, in particular, the mass ratio of the active material can be made larger than that of the conventional electrode.

Further, since the electrode does not require an organic binder, it is possible to prevent the organic binder from adhering to the crystal surface of the active material nanoparticles and reducing the contact area between the active material nanoparticles and the electrolyte solution (hereinafter, also referred to as an electrolyte). As a result, the electrode can utilize the active material nanoparticles more sufficiently than in the past, and can efficiently take in and out electrons from the active material nanoparticles through the carbon nanotubes with low resistance. Furthermore, since the electrode does not require an organic binder, it is also possible to prevent a binder from inhibiting the structural strain (volume change) of the active material caused by the de-insertion and insertion of ions.

With the new electrode structure of the electrode, an appropriate space into which the electrolyte solution can enter is maintained, and each of the active material nanoparticles can be efficiently brought into contact with the electrolyte solution. In addition, the carbon nanotubes serving as conductive auxiliary agents serve to take electrons in and out of the active material nanoparticles with low resistance.

Since the electrode has the above-described configuration and function, it is an electrode for a secondary battery that can draw out the high-speed charge-discharge capability inherent in the active material, and achieves an excellent balance between high energy density and high-speed charge and discharge characteristics. The electrode can also obtain capacity of preferably 85% or more, more preferably 90% or more, even more preferably 95% or more, and even more preferably substantially 100% of the theoretical capacity.

The active material particles included in the electrode may have a spherical shape, a polygonal shape, a wire shape, a plate shape, an irregular shape, or the like.

The active material particles included in the electrode have an average particle size of 2 to 1000 nm, preferably 10 to 800 nm, more preferably 20 to 600 nm, and still more preferably 30 to 500 nm.

When the average particle diameter of the active material particles is within the above range, the diffusion distance of ions is shortened, which is advantageous for high-speed charging and discharging of the battery, and the contact area of the active material particles with respect to the electrolyte solution is increased because the surface area of the active material particles is large, which is advantageous for high-speed charging and discharging, and is advantageous for reducing the stress of lattice strain of the active material and improving the high-speed charging and discharging and cycle characteristics. On the other hand, conventionally, when the particle diameter of active material particles is small, aggregation tends to occur, and also, since the electron conduction path is easily divided, it is necessary to increase the content of the conductive auxiliary agent, in the present electrode, the active material particles and the carbon nanotubes are well dispersed in the electrode, the active material particles are fixed in a state in which individual dispersed in the network made of carbon nanotubes. Therefore, the electrode can achieve both the ion transfer path and the electron conduction path even if the content of the carbon nanotubes is small. The average particle diameter of the active material particles is an equivalent circular diameter measured based on the SEM image. The equivalent circular diameter is the diameter of the smallest circle surrounding the particle.

The carbon nanotubes included in the electrode may be single-walled carbon nanotubes (SWNTs) or relatively inexpensive multi-walled carbon nanotubes (MWNTs), but are preferably single-walled carbon nanotubes. Since the single-walled carbon nanotubes are thinner than the multi-walled carbon nanotubes, the single-walled carbon nanotubes tend to form bundles, and the entire bundle can be made longer, so that the electron conductivity of the electrodes can be further improved. The carbon nanotubes may be commercially available, for example TUBALL® from OCSiAl. In addition, a commercially available product of carbon nanotubes having a substituent such as a carboxylic acid group or an amino group introduced on the surface thereof can be used or synthesized as appropriate.

The method for producing the carbon nanotubes is not particularly limited, but may be, for example, a single-walled carbon nanotube produced by the eDIPS method (enhanced Direct Injection Pyrolytic Synthesis method). Single-walled carbon nanotubes produced by the eDIPS method are preferable because they have excellent crystallinity and conductivity. The eDIPS method is a kind of the Catalytic Gas-Phase Reaction Method which further evolves the Gas Phase Flow Method which is a kind of chemical vapor deposition (CVD) method, and is a method for synthesizing carbon nanotubes by a continuous method without using a substrate.

The carbon nanotubes included in the electrode may have a diameter of 1 to 3 nm and a length of the order of 5 μm to 1 mm. The carbon nanotubes included in the electrode may have an aspect ratio of about 1667 to 10000.

The carbon nanotubes included in the electrode are preferably present in the electrode in a plurality of bundles. By forming a bundle of carbon nanotubes, the carbon nanotubes can be elongated to form a continuous path, and the electron conductivity of the electrode can be further improved. The number of the carbon nanotubes adjacent to each other in the diametrical direction constituting the bundle may be about 2 to 500. In addition, since the elongated carbon nanotubes are well entangled with the active material particles, the electrode structure can be retained in an organic binder-free state.

### Mass Ratio of Carbon Nanotubes Contained in Electrode

The mass ratio of the carbon nanotubes to the total mass of the active material particles and the carbon nanotubes in the electrode is 0.1 wt % or more, preferably 0.5 wt % or more, more preferably 1.0 wt % or more, still more preferably 1.5 wt % or more, and still more preferably 2.0 wt % or more. Since the electrode has excellent dispersibility of the active material particles, the electrode can have good electron conductivity and ion conductivity even if the mass ratio of the carbon nanotubes functioning as the conductive auxiliary agents is small. Therefore, the lower limit of the mass ratio of the carbon nanotubes is made possible from a range as small as 0.1 wt % or more, it is possible to obtain better C-rate characteristics in the above preferred range. Further, in the present electrode, the mass ratio of the carbon nanotubes functioning as the conductive auxiliary agents can be reduced to about 1/10 or less as compared with the conventional electrode manufacturing method of kneading an active material, a conductive auxiliary agent, and an organic binder. Consequently, it is possible to relatively increase the ratio of the active material particles in the electrode, obtain superior electrode characteristics compared to the prior art, reduce the proportion of relatively expensive carbon nanotubes, and lower the cost of the electrode.

In the electrode, even if the mass ratio of the carbon nanotubes in the electrode is increased, the battery capacity per unit mass of the active material can have a constant value, and therefore the upper limit of the mass ratio of the carbon nanotubes is not particularly limited. However, if the mass ratio of the carbon nanotubes to the active material is too large, the effect as a conductive auxiliary agent is saturated and the battery capacity per unit volume of the electrode is reduced, so that the mass ratio of the carbon nanotubes to the mass of the active material particles may be 25 wt % or less, 20 wt % or less, 15 wt % or less, 10 wt % or less, 5 wt % or less, 4 wt % or less, or 3 wt % or less.

In the present electrode, the ratio of the number of primary particles to the number of all particles of the active material particles is preferably 70% or more, more preferably 75% or more, still more preferably 80% or more, and still more preferably 85% or more. When the ratio of the number of primary particles is within the above-described preferable range, the active material particles are better dispersed in the network made of carbon nanotubes, and thus excellent battery capacity and high-speed charge and discharge characteristics can be obtained.

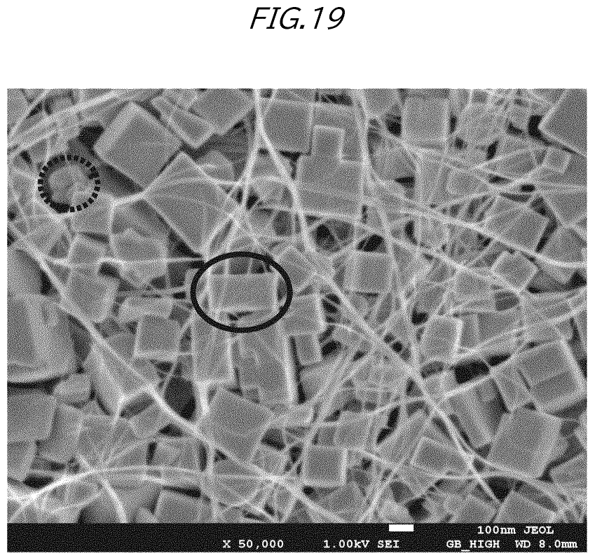

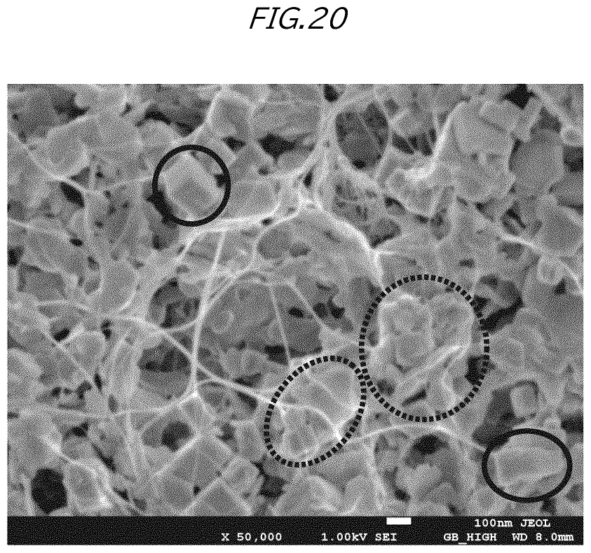

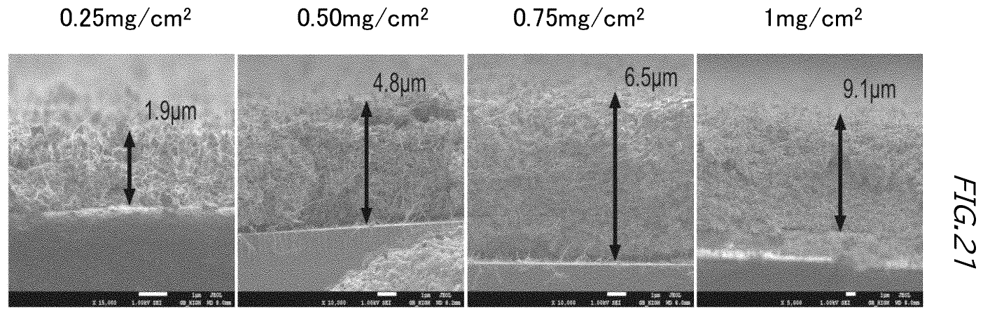

Scanning electron microscopy (SEM) is used to observe the shape of the particles at a magnification that can be clearly grasped, to determine what has a clear contour as primary particles (isolated particles), and to determine what particles overlap and have an ambiguous contour as aggregated particles. FIG. 19 and FIG. 20 show an example in which the particles are determined as primary particles and an example in which the particles are determined as aggregated particles. FIG. 19 is an SEM image obtained by observing the electrode from the surface, and FIG. 20 is an SEM image obtained by observing an electrode prepared by a conventional suspension process from the surface. The particles surrounded by the solid line are determined as primary particles, and the particles surrounded by the broken line are determined as aggregated particles. When the ratio of the primary particle number to all the particle numbers of the active material particles is within the above-described preferable range, it means that the active material particles are more preferably monodispersed in the electrode, and an electrode having more excellent performance can be obtained. The ratio of the number of primary particles can be calculated from the following formula (1) by measuring the number of primary particles and the number of aggregated particles based on an SEM image:

$$The ratio of the number of primary particles ( \% ) = number of primary particles ) / number of primary particles + number of aggregated particles ) \times 100 . \qquad ( 1 )$$

The CV value (distribution: (σ1/D1)×100) of the inter-particle distance of the active material particles included in the electrode is preferably 40% or less, more preferably 20% or less, still more preferably 10% or less, and still more preferably 5% or less. D1 is the average of the inter-particle distances, and σ1 is the standard deviation thereof. When the CV value of the inter-particle distance is within the above-described preferable range, it means that the active material particles are better dispersed in the electrode, and an electrode having better performance can be obtained. The measurement of the inter-particle distance can be performed by measuring the distance between the centers of gravity using the Voronoi region.

The CV value (particle size distribution: (σ2/D2)×100) of the average particle diameter of the active material particles contained in the electrode is preferably 40% or less, more preferably 20% or less, still more preferably 10% or less, and still more preferably 5% or less. D2 is the average value of the average particle size and σ2 is the standard deviation thereof. When the average particle diameter is within the above-described preferable range, the active material particles can be uniformly dispersed at a higher density in the electrode.

The electrode may comprise a binder, but preferably does not comprise a binder, because the electrode shape and properties can be maintained without the need for a binder. When a binder is not included, it is possible to prevent a binder from inhibiting ion conduction and electron conduction with respect to the active material. In addition, in an active material having a large change in volume with respect to the de-insertion and insertion of ions, when a binder adheres to the surface thereof, the change in volume can be inhibited, and therefore, the high-speed charge and discharge performance and the life can be deteriorated. However, by not including a binder, the volume changes are not inhibited, and high-speed charge and discharge performance and cycle characteristics (life) can be improved. Since the volume ratio of the active material and the carbon nanotube in the electrode can be increased by an amount that does not include the binder, an electrode having better performance can be obtained.

The active material particles included in the electrode can improve the battery capacity and the high-speed charge and discharge characteristics by the active material particles being relatively uniformly dispersed in the electrode.

The active material particles included in the electrode may have a positive or negative surface charge (zeta potential). When the active material particles have a positive or negative surface charge (zeta potential), in the step of preparing a dispersion liquid of the active material particles in a method for producing the electrode described later, the active material particles repel each other, so that the active material particles can be favorably dispersed in the dispersion liquid as primary particles with few aggregated particles. By mixing the dispersion liquid in which the active material particles are well dispersed as the primary particles and the dispersion liquid of the carbon nanotubes, the electrode in which the active material particles are dispersed in the matrix of the carbon nanotubes as the primary particles can be obtained. The surface charge can be imparted to the active material particles by a surface charge imparting treatment by addition of a dispersant in a method of manufacturing the electrode described later. The positive or negative surface charge (zeta potential) of the active material particles can be measured by DLS for the dispersion liquid of the active material particles. The active material particles can be isolated from the electrode and dispersed in water or an organic solvent such as alcohol, and the positive or negative surface charge (zeta potential) of the active material particles can be measured by DLS. The optimum surface charge (zeta potential) for favorably dispersing the active material particles as the primary particles varies depending on the material, shape, and size of the active material particles, but has a surface charge (zeta potential) that is larger as an absolute value than that in the case where the above-described surface charge application treatment is not performed, and is, for example, −30 to −150 m V.

Alternatively, the active material particles included in the electrode may have surface modifying molecules. The surface modifying molecules are molecules having an affinity for a solvent of a dispersion liquid that can be used in an affinity treatment method in a method for producing the electrode described later. When the active material particles have surface modifying molecules, the number of aggregated particles is small in the solvent of the dispersion liquid, and the particles can be well dispersed in the electrode as primary particles. By mixing the dispersion liquid in which the active material particles are well dispersed as the primary particles and the dispersion liquid of the carbon nanotubes, the electrode in which the active material particles are dispersed in the matrix of the carbon nanotubes as the primary particles can be obtained. As the surface protection molecule of the active material particles, preferably, a substance that does not inhibit the de-insertion and insertion of electrolyte ions can be used, and for example, water-soluble polymers such as Nafion, polyvinylpyrrolidone, polyvinyl alcohol, polystyrene sulfonic acid, polyvinyl acetate, polyethylene glycol, and Demol N, as well as sodium bis(2-ethylhexyl)sulfosuccinate, polymethyl methacrylate, and polyoxyethylene nonylphenyl ethers can be used.

When the active material particles have a negative surface charge (negative zeta potential), it is preferable because they can electrostatically attract cations such as Li⁺, Na⁺, and K⁺ in the electrolyte solution within the electrode.

As a material of the active material particles included in the electrode, an active material that can be used as an active material of an ion secondary battery can be used. The active material may include, for example, Prussian blue (PB) or an analog thereof (PBA), a metal-organic framework (MOF) having various transition metal ions as a skeleton, lithium cobalt oxide (LiCoO₂), lithium nickel oxide (LiNiO₂), lithium manganese oxide (LiMn₂O₄), LiCo_{1/3}Ni_{1/3}Mn_{1/3}O₂, a heteroatom-substituted Li—Mn spinel with a composition represented by Li₁₊ₓMn_{2-x-y}M_{y}O₄ (M is one or more metal elements selected from Al, Mg, Co, Fe, Ni, Zn, and the like), lithium titanate (LiₓTiO_{y}), lithium metal phosphate (LiMPO₄, where M is Fe, Mn, Co, or Ni), transition metal oxides such as vanadium oxide (V₂O₅), and molybdenum oxide (MoO₃), transition metal phosphate compounds, transition metal sulfides such as titanium sulfide (TiS₂), carbon materials such as graphite and hard carbon, transition metal carbides, and transition metal nitrides such as lithium cobalt nitride (LiCON).

The active material particles included in the electrode are preferably particles of Prussian blue (PB) or an analog thereof (PBA). Prussian blue or an analog thereof is a porous coordination polymer similar to MOF and is characterized by a high diffusion rate of ions within the pores due to its porosity. By suppressing the structural strain by the metal composition, it is possible to reduce the stress due to the de-insertion and insertion of the ions. Therefore, the electrode including Prussian blue or an analog thereof as an active material can obtain a discharge capacity relatively close to the theoretical capacity.

Prussian blue and its analogs can intercalate and deintercalate multivalent ions such as Zn²⁺ and Al³⁺ in addition to alkali metal ions such as Li⁺, Na⁺, and K⁺, and alkaline earth metal ions such as Mg²⁺ and Ca²⁺. In addition, Prussian blue analogs can have various metal compositions, and can be synthesized inexpensively because, for example, various transition metals such as Fe, Mn, Zn, and Cu and main group elements can be used in combination of two or more kinds. The Prussian blue analog is preferably Fe—Zn Prussian blue or an analog thereof (hereinafter also referred to as Fe—ZnPBA or ZnPBA), Fe—Mn Prussian blue or an analog thereof (hereinafter also referred to as Fe—MnPBA or MnPBA), or Fe—Cu Prussian blue or an analog thereof (hereinafter also referred to as Fe—CuPBA or CuPBA). Prussian blue analogs contain a variety of metals, making structural strain less likely. By using Fe—MnPBA particles as an active material, a high-speed charge and discharge secondary battery having a higher capacity than that of Fe—ZnPBA and exceeding 100 mAh/g can be obtained. Further, by using a metal such as Li, Na, K, Mg, Ca, and Al in addition to Zn as a counter electrode, a metal ion secondary battery having a higher voltage and a higher energy-density can be obtained. As the active material, a redox-active organic material such as 3,4,9,10-perylenetetracarboxylic acid diimide having a property insoluble in an electrolyte solution can also be used.

Fe—ZnPBA has theoretical capacity of 55 to 75 mAh/g. Fe—ZnPBA has a basic composition of Znₓ[Fe(CN)₆]_{y}. Fe—ZnPBA is capable of de-insertion and insertion of ions such as K⁺ and Na⁺ contained in electrolyte solutions. In Fe—ZnPBA, only iron is a redox site, which can store electric energy, but by substituting Znₓ with Mn, Fe, or the like, oxidation-reduction of Mn, Fe, or the like is added, it is possible to store larger electric energy to increase the capacity.

Fe—MnPBA has a large theoretical capacity of 150 to 170 mAh/g. Fe—MnPBA has a basic composition of Mnₓ[Fe(CN)₆]_{y}. Fe—MnPBA is capable of de-insertion and insertion of ions such as K⁺ and Na⁺ contained in the electrolyte solutions. For example, when used as a positive electrode of a Zn-ion battery, MnPBA is capable of de-insertion and insertion of K⁺ in a mixed electrolyte solution composed of 1M Zn²⁺ and 2M K⁺ to enable high-speed charging and discharging. For example, at 100 C, it has energy density of 60 Wh/kg or more (140 Wh/kg), power density of 10000 W/kg or more (23000 W/kg), and a capacity retention ratio of 60% or more, at 150 C, has energy density of greater than 100 Wh/kg (126 Wh/kg) and power density of 10000 W/kg or more (34000 W/kg), and, even after 80 cycles at 100 C, further has energy density of 120 Wh/kg or more, power density of 32000 W/kg or more, and an excellent capacity retention rate of 60% or more. Similar battery properties can also be obtained in mixed electrolyte solutions consisting of 1M Zn²⁺ and 2M Na⁺. The capacity retention ratio is a ratio of the capacity based on the capacity at the time of 1 C and 1 cycle.

Fe—CuPBA has theoretical capacity of 50-70 mAh/g. Fe—CuPBA has a basic composition of Cuₓ[Fe(CN)₆]_{y}. Fe—CuPBA is capable of de-insertion and insertion of ions such as K⁺ and Na⁺ contained in electrolyte solutions. For example, when used as a positive electrode of a Zn-ion battery, CuPBA is capable of de-insertion and insertion of K⁺ in a mixed electrolyte solution composed of 1M Zn²⁺ and 2M K⁺ to enable high-speed charging and discharging. A battery using CuPBA as a positive electrode can obtain energy density of 60 Wh/g or more and power density of 35000 W/kg or more even after 100 cycles at 500 C.

The thickness of the electrode is not particularly limited, and is, for example, about 0.5 to 100 μm.

The electrode of the present disclosure can fully function as an electrode when used in the secondary battery, while the redox reaction of the counter electrode may become the rate-determining step. Therefore, the rate characteristics of the secondary battery can be further improved by adjusting the loading amount of the active material in the electrode of the present disclosure. The loading amount of the active material can be adjusted according to the object, and is not particularly limited, but is preferably 0.1 to 1.0 mg/cm². For example, when the loading amount of the active material is 1.0 mg/cm², the secondary battery can have a capacity retention ratio of 90% or more up to 300 C and 80% or more up to 400 C, and when the loading amount of the active material is 0.5 mg/cm² or less, the secondary battery can have a capacity retention ratio of 90% or more up to 1000 C.

Conventionally, increasing the C-rate of a secondary battery causes the insertion and extraction of ions in the cathode to become insufficient to keep up, but in the secondary battery using the electrode, increasing the C-rate causes the redox reaction of the counter electrode to become unable to keep up, thereby limiting the battery performance. Therefore, in the secondary battery using the electrode, when the amount of the active material supported in the electrode is reduced according to the oxidation-reduction rate of the counter electrode, the capacity can be maintained even at a high C-rate accordingly. In order to fully exhibit the function of the electrode, for example, if a counter electrode having an improved oxidation-reduction rate by increasing the surface area or the like can be obtained, the capacity can be maintained at a high C-rate even if the loading amount of the active material of the electrode is increased. As described above, the electrode is the only electrode capable of sufficiently exhibiting the performance of the positive electrode material in the secondary battery.

The secondary battery including the electrode of the present disclosure has excellent high-speed charge and discharge characteristics (C-rate characteristics), and can retain high capacity of preferably up to 100 C, more preferably up to 200 C, even more preferably up to 400 C, even more preferably up to 600 C, and even more preferably up to 1000 C, and can retain capacity of preferably 60% or more, more preferably 70% or more, still more preferably 75% or more, still more preferably 80% or more, still more preferably 85% or more, and even more preferably 90% or more of the capacity at 1 C. In the present specification, the C-rate characteristic is evaluated on the basis of the capacity at 1 C. The reason for using the capacity at 1 C as the standard rather than the theoretical capacity is to ensure that any discrepancies that may occur between the design value for the loading amount of active material and the actual loading amount of active material when the electrode is prepared do not affect the evaluation of the C-rate characteristics. In the secondary battery using the electrode, the capacity at a rate smaller than 1 C, for example, 0.1 C and the capacity at 1 C are substantially the same, and the capacity does not substantially decrease in the range of more than 0 C to 1 C.

The secondary battery including the electrode of the present disclosure exhibits preferably energy density of 60 Wh/kg or more and power density of 30000 W/kg or more, more preferably energy density of 70 Wh/kg or more and power density of 30000 W/kg or more, still more preferably energy density of 80 Wh/kg or more and power density of 30000 W/kg or more, still more preferably energy density of 85 Wh/kg or more and power density of 30000 W/kg or more. The secondary battery comprising the electrode of the present disclosure also exhibits preferably energy density of 120 Wh/kg or more and power density of 10000 W/kg or more, more preferably energy density of 140 Wh/kg or more and power density of 10000 W/kg or more, even more preferably energy density of 160 Wh/kg or more and power density of 10000 W/kg or more.

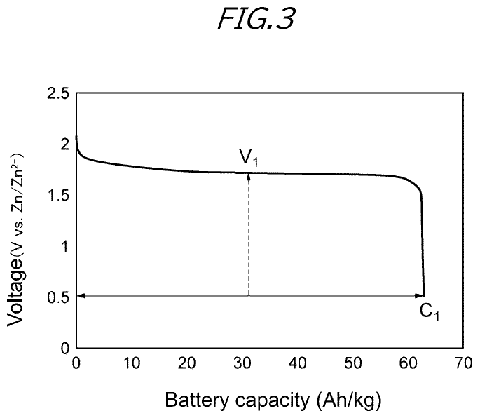

With reference to FIG. 3, a method of obtaining a numerical value of the Ragone plot will be described. FIG. 3 is an example of the discharge curve. The energy density (Wh/kg) is calculated based on the following formula (2):

$$Energy density ( Wh / kg ) = {V}_{1} \times {C}_{1} \qquad ( 2 )$$

wherein V₁ (V) is the voltage at half the capacity in the graph of FIGS. 20 and C₁ is the discharge capacity (Ah/kg) in the graph of FIG. 3.

The power density (W/kg) is calculated based on following formula (3):

$$Power density ( W / kg ) = {V}_{1} \times {C}_{1} / Y \qquad ( 3 )$$

wherein Y (hour) is a value obtained by converting a unit into time by dividing the time (seconds) required for measurement by 3600.

The secondary battery with the electrode of the present disclosure has a capacity retention ratio C₁₀₀/C₁ at 100 C to the capacity at 1 C is preferably 60% or more, more preferably 70% or more, still more preferably 80% or more, and still more preferably 90% or more.

The secondary battery with the electrode of the present disclosure preferably has a capacity retention ratio of 80% or more when obtaining energy density of 60 Wh/kg or more and power density of 10000 W/kg or more.

The secondary battery with the electrode of the present disclosure preferably has a capacity retention ratio of 60% or more when obtaining energy density of more than 100 Wh/kg and power density of 10000 W/kg or more.

The secondary battery with the electrode of the present disclosure has a capacity retention ratio of preferably 95% or more, more preferably 97% or more of the theoretical capacity after 200 charge and discharge cycles at 400 C. The secondary battery with the electrode of the present disclosure also has a capacity retention ratio of preferably 85% or more, more preferably 90% or more of the theoretical capacity after 50000 charge and discharge cycles at 400 C. The secondary battery with the electrode of the present disclosure also has a capacity retention ratio of preferably 80% or more, more preferably 85% or more of the theoretical capacity after 100000 charge and discharge cycles at 400 C.

The present disclosure is also directed to a secondary battery comprising the electrode as described above, a counter electrode, an electrolyte solution, and a current collector.

The solvent of the electrolyte solution included in the secondary battery may be an organic solvent, water, or a mixed solvent thereof. The organic solvent is preferable in that it is effective in inhibiting the growth of dendrites on the negative electrode, and water is preferable in terms of the environment. Water can be preferably used because it can dissolve the electrolyte at a high concentration and its ion conduction is high. On the other hand, when a solvent containing only water is used, the active material may easily dissolve in water and deteriorate battery performance. Therefore, a solvent obtained by mixing water and an organic solvent in an appropriate volume ratio can also be suitably used.

When water is used as the solvent, the metal that can be used in the negative electrode is limited, but the organic solvent is preferable in that various metals can be used in the negative electrode. As the organic solvent, a phosphate ester having a self-extinguishing property is preferably used from the viewpoint of safety. As the mixed solvent, for example, a solvent obtained by mixing water and an organic solvent in an appropriate volume ratio (for example, a mixed solvent of water and propylene carbonate) is preferably used. When the mixed solvent is used, the electrolyte is dissolved at a high concentration, and the ion conduction thereof is also increased, and at the same time, the active material is prevented from being dissolved, and the formation of dendrites can also be suppressed. In addition, by including water and a high concentration electrolyte, ignition of the electrolyte solution can be suppressed. As the organic solvent for dissolving the salt of the electrolyte, a water-soluble or water-insoluble organic solvent conventionally used as an organic solvent of a secondary battery can be used, and for example, phosphoric acid esters such as triethyl phosphate, carbonic acid esters such as propylene carbonate, amides such as N,N-dimethylformamide, alkyl sulfoxides such as dimethyl sulfoxide, glycol ethers such as diglyme and triglyme, esters such as butyl acetate, nitriles such as acetonitrile, and the like can be used.

In the secondary battery, the electrolyte may be a polymer electrolyte, a polymer gel electrolyte, eutectic electrolytes, or a combination thereof, in addition to aqueous electrolytes, organic solvent electrolytes, or ionic liquids, which are electrolytes that exhibit fluidity that allows them to easily enter the voids and gaps in the electrodes. The salt of the electrolyte used by dissolving in water or an organic solvent may be a salt of an electrolyte conventionally used in a secondary battery, and for example, trifluoromethanesulfonate, trifluoroacetate, di[bis(trifluoromethylsulfonyl)imide] salt, bis(fluorosulfonyl)amide salt, bis(pentafluoroethanesulfonyl)amide salt, hexafluorophosphate, tetrafluoroborate, acetate, chloride, perchlorate, sulfate, nitrate, or the like can be used. The salt may be a salt consisting of a desired alkali metal ion, an alkaline earth metal ion, a typical metal ion such as Al³⁺, a transition metal ion, or a combination thereof. Electrodes in which multivalent cations with small atomic weights, such as Mg²⁺, Ca²⁺, and Al³⁺, are intercalated and deintercalated as electrolyte ions can have large capacity, while the energy-change of solvation/de-solvation associated with de-insertion and insertion into the electrodes is large. The monocations Li⁺, Na⁺, and K⁺ are preferable from the viewpoint of facilitating high-speed charging and discharging. In addition, a mixed electrolyte solution in which two or more kinds of different cations are mixed at an arbitrary ratio can be suitably used in order to cause different cations to be inserted and extracted into the positive electrode and the negative electrode.

The concentration of the electrolyte solution (the concentration of the electrolyte in the electrolyte solution) is preferably 0.2M or more, more preferably 0.3M or more, still more preferably 0.8M or more, and still more preferably 1M or more. The higher the electrolyte concentration, the lower the capacity of the secondary battery can be suppressed even if the C-rate is increased. In the secondary battery, for example, when the electrolyte concentration is 0.8M or more, a capacity retention ratio of 90% or more can be obtained at 100 C, and a capacity retention ratio of 85% or more can be obtained at 200 C.

In the battery, the plateau region can be clearly identified, and even at high C, a clear plateau can be shown. The battery also has a higher voltage in the plateau region as the electrolyte concentration increases. When the concentration of the electrolyte solution is 0.8M or more, the plateau region can be clearly confirmed even at 200 C. The slope of the plateau region is expressed as a voltage change (ΔV) with respect to a constant capacity change (Δ cell capacity (mAh/g)), and the battery has a slope of the plateau region at 100 C, preferably less than or equal to −0.0060, more preferably less than or equal to −0.0050, and even more preferably less than or equal to −0.0040. In the present application, the slope of the plateau region is an average slope in the range of the center 60% of the inflection point 1 on the low-capacity side and the inflection point 2 on the high-capacity side obtained from the differential curve of the discharge curve as illustrated in FIG. 15.

As the counter electrode, a metal or an alloy material can be used, and examples thereof include an alkali metal such as lithium, sodium, and potassium, an alkaline earth metal such as magnesium and calcium, a Group 13 element such as aluminum, a transition metal such as zinc, iron, nickel, and copper, or an alloy material containing these metals. Preferably, the counter electrode is a metal foil of zinc or aluminum. An ion secondary batteries with a counter electrode of zinc or aluminum is preferable in that water or a solvent made from a mixture of water and organic solvent can be used as the solvent of the electrolyte solution.

The current collector can be positioned adjacent to the electrode. The current collector disposed adjacent to the electrode is not particularly limited as long as it is a material conventionally used as a current collector, such as a metal foil, or a porous structure such as carbon paper, graphite paper, carbon cloth, metal mesh, or metal foam, a mesh structure, a fiber, or a nonwoven fabric, and for example, a metal foil, a mesh, or a foam formed of SUS, nickel, aluminum, iron, titanium, or the like can be used.

The current collector can be positioned adjacent to the counter electrode. The current collector disposed adjacent to the counter electrode is not particularly limited as long as it is a material conventionally used as a current collector, such as a conductive substrate having a porous structure or a non-porous metal foil, and for example, a metal foil formed of copper, SUS, nickel, or the like can be used.

Preferably, the electrode described above is a positive electrode and the counter electrode is a negative electrode.

The secondary battery can have the preferred battery characteristics described above.

The present disclosure is also directed to a method for producing an electrode for a secondary battery, comprising: surface-modifying active material particles having an average particle size of 2 to 1000 nm to prepare a dispersion liquid of the active material particles in which the surface-modified active material particles are dispersed; preparing a dispersion liquid of carbon nanotubes; mixing the dispersion liquid of the active material particles and the dispersion liquid of the carbon nanotubes so that a mass ratio of the carbon nanotubes to a total mass of the active material particles and the carbon nanotubes is 0.1 wt % or more to form a mixed liquid; and filtering the mixed liquid through a filter to obtain a filtration membrane.

According to the present method, by mixing the dispersion liquid of active material nanoparticles in which active material nanoparticles are dispersed in a solvent such as water in advance by chemical surface modification and the dispersion liquid of carbon nanotubes which are conductive auxiliary agents, and filtering the mixture through a filter, it is possible to obtain an organic binder-free electrode in which active material particles are entangled in carbon nanotubes with good dispersibility. In the method for preparing the dispersion liquid of active material particles in the present method, the active material nanoparticles can be dispersed in a solvent such as water by performing chemical surface modification on the surface of the active material nanoparticles in advance, instead of a physical method such as ultrasonic waves.

Although the aggregated active material particles are not dissolved in water or an organic solvent, in the present method, by bonding protective molecules or ions to the elements exposed on the surface of the active material particles, the active material particle surface bears a predetermined range of charge, it is possible to substantially independently disperse the active material particles without aggregating by electrostatic repulsion.

The active material particles contained in the electrode are composited with the carbon nanotubes by using a dispersion liquid existing as primary particles whose aggregation is suppressed in the solvent by surface modification in advance. As a method for obtaining a dispersion liquid in which active material particles are dispersed as primary particles, a general method can be used, and the following methods (A) to (C) are preferably exemplified.
(A) A surface charge imparting treatment method wherein a positive or negative surface charge (zeta potential) is imparted to the active material particles by adding a dispersant to a solvent in which disperses the active material particles, and the active material particles are well dispersed in the solvent by the electrostatic repulsion;
(B) A solvent affinity treatment method wherein the active material particles are dispersed in a solvent by surface modification with a molecule having affinity for the solvent; or
(C) A method of dispersing the active material particles using (A) and (B) together.

The dispersant (charge imparting molecule) used in the method (A) can be bonded to bondable coordination sites exposed on the surface of the active material particles. The active material particles having the dispersant bonded to the coordination site surface can be dispersed as primary particles in the solvent by electrostatic repulsion between the particles, with the surface having a positive or negative charge. Depending on the material and surface area of the active material particles, a dispersant may be added in an amount capable of coordinating to most of the coordination sites capable of binding the active material particle surface, and the mixture may be sufficiently stirred. In the electrode, the dispersion liquid of the active material particles prepared by the method (A) having a positive or negative surface charge can be used by being mixed with the dispersion liquid of the carbon nanotubes as it is. The positive or negative surface charge of the active material particles can be measured by DLS for the dispersion liquid of the active material particles.

In the dispersion liquid prepared by the method (B), as long as the surface-modified molecules do not inhibit ion conduction or electron conduction of the active material particles, they can be used as they are in the electrode. When the surface-modified molecules inhibit ion conduction or electron conduction of the active material particles, the surface-modified molecules can be removed by heat treatment in a temperature range in which the active material particles do not decompose, or by washing the electrode with a solvent.

By the above-described method, the dispersion liquid of the active material particles that are well dispersed as primary particles can be obtained. By using this dispersion liquid, it is possible to obtain the electrode in which the active material particles are well-dispersed as primary particles, with minimal particle aggregation. The active material particles can be substantially independently dispersed by the above-described method or the like, and a secondary battery having excellent battery capacity and high-speed charge and discharge characteristics can be obtained.

Hereinafter, the above-described methods (A) to (C) will be described, taking a case where the active material particles are Prussian blue (PB) as an example.

Preparing a dispersion liquid of active material particles in which surface-modified active material particles are dispersed includes, for example, (a) mixing an aqueous solution containing an anionic metal cyano complex having a metal atom M1 as a center metal and an aqueous solution containing a metal cation having a metal atom M2, and precipitating a crystal of a Prussian blue-type metal complex having the metal atom M1 and the metal atom M2, and then (b) mixing a solution in which a ligand L is dissolved in a solvent and a crystal of the Prussian blue-type metal complex to form a dispersion liquid of Prussian blue metal complex ultrafine particles.

As an example of the method (B), when water (OH₂) coordinated to the metal on the surface of the PB particle is substituted with an organic compound having an alkyl chain, the hydrophobic interaction on the surface of the PB improves the affinity with the hydrophobic organic solvent and the PB particles become independently dispersed (dissolve in an ink-like state). That is, the organic compound having an alkyl chain is used as a dispersant. The organic compound having an alkyl chain is preferably an alkylamine having an amino group.

As an example of the method (A), when ferrocyanide ions or ferricyanide ions are bonded to the surface of the PB particles by substituting water (OH₂) coordinated to the metal of the surface of the PB particles via cyanide ligands, the charge on the surface of the PB becomes negative (bears a negative zeta potential), and the particles can be well independently dispersed, in particular with respect to water, by electrostatic repulsion between the particles.

As an example of the method (C), PB particles can be dispersed well in a hydrophilic organic solvent by surface modification with an appropriate mixture of an organic compound with an alkyl chain and ferrocyanide ions or ferricyanide ions.

The surface-bound alkylamines and the like can be removed from the PB surface by heating under normal pressure or reduced pressure at a temperature at which the PB is not thermally decomposed after the production of the electrode, if the alkylamines or the like is an organic molecule having a low vapor pressure, thereby facilitating the de-insertion and insertion of electrolyte ions into the PB nanoparticles. Alternatively, even if the surface-bound alkylamines and the like are organic molecules having a high vapor pressure, they can be removed by sufficiently washing with a solvent such as alcohols, nitriles, amides, sulfoxides, or fatty acids, which has a weak coordination force to the metal on the surface, thereby facilitating the de-insertion and insertion of electrolyte ions into the PB nanoparticles. The washing solvent also preferably has a low boiling point because it needs to be removed after the removal of the alkylamines and the like, but the washing solvent can also be washed with another low boiling point solvent and substituted.

When the active material particles are Prussian blue and its analogs (PBA), coordination site to which the dispersant can be bonded, which is exposed on the crystal surface, changes depending on the particle diameter. In the case of a cubic crystal of 10 nm, coordination sites of about 15 mol % of the total amount of metal exist, and in the case of a cubic crystal of 100 nm, coordination sites of about 1.5 mol % of the total amount of metal exist. A sufficient amount of dispersant may be added and stirred to coat the coordination sites on the crystal surface.

When the active material particles are other than Prussian blue (PB), for example, even in the case of a metal oxide, a dispersion liquid of the active material particles in which the active material particles surface-modified by the above-described method or the like are dispersed can be prepared. For example, an aqueous solution of a surfactant such as sodium dodecyl sulfate (SDS) or sodium dodecylbenzene sulfonate (SDBS) is added to a metal oxide nanoparticle powder, and the mixture is stirred or subjected to ultrasonic treatment, whereby the nanoparticle powder can be dispersed in water. Also, for example, an aqueous dispersion of the nanoparticle powder can be obtained by mixing and stirring the metal oxide nanoparticle powder with an aqueous polymer solution having a water-soluble functional group such as a carboxylic acid such as polymethacrylic acid.

### Dispersion Liquid of Carbon Nanotubes

The dispersion liquid of the carbon nanotubes can be commercially available, such as TB004M manufactured by KJ Special Paper Co., Ltd., EC1.5 manufactured by Meijo Nano Carbon Co., Ltd., and 9487SW manufactured by Tokushiki Co., Ltd. The concentration of the dispersion liquid of carbon nanotubes is preferably 0.005 to 5 wt %, more preferably 0.015 to 3 wt %. If desired, the dispersion liquid of carbon nanotubes having the preferred concentration may be diluted and used. The dispersion liquid of the carbon nanotubes may be prepared by dispersing the carbon nanotubes in water, an organic solvent, or a mixed solvent thereof using a surfactant and optionally an ultrasonic treatment.

### Method for Producing Electrode Film

A method for producing an electrode film from the mixed liquid of the dispersion liquid of active material particles and the dispersion liquid of carbon nanotubes is not particularly limited, but preferably, the electrode film can be produced using a filtration method in which the mixed liquid of the dispersion liquid of active material particles and the dispersion liquid of carbon nanotubes is filtered. In the filtration method, the electrode having a binder-free structure can be formed by utilizing a filtration pressure at the time of filtering the mixed liquid, and an excess dispersant used in preparing the dispersion liquid of active material particles as well as an excess surfactant contained in a commercially available carbon nanotube dispersion liquid can be removed by a filtration washing step. The filter used in the filtration method is preferably a chemically stable polytetrafluoroethylene (PTFE) membrane. The PTFE membrane on which the electrode film is formed by the filtration method can function as a separator in configuring a battery.

Alternatively, the mixed liquid of the dispersion liquid of active material particles and the dispersion liquid of carbon nanotubes may be spray coated and deposited on a heated filter, followed by washing and removing the surfactant with water. Alternatively, if the mixed liquid of the dispersion liquid of the active material particles and the dispersion liquid of the carbon nanotubes is in the form of a paste having a high concentration, it may be applied directly to a current collector such as carbon paper. Before forming the electrode film, a high-concentration active material particle dispersion liquid and a high-concentration carbon nanotube dispersion liquid may be mixed and stirred in advance, and the active material particles may be entangled with the carbon nanotubes, and then centrifuged to remove an excess of the surfactant contained in the carbon nanotube dispersion liquid and an excess of the dispersant used in preparing the dispersion liquid of the active material particles, and the centrifuged material may be kneaded with various solvents to be applied to a current collector such as carbon paper.

### EXAMPLES

Hereinafter, the present invention will be described in detail with reference to the Examples, but the present invention is not limited to the Examples.

### (Example 1) Preparation of Binder-Free Electrode of ZnPBA and Battery Characteristics Thereof

### Synthesis of ZnPBA Powder

0.961 g of zinc nitrate hexahydrate (2.28×10⁻³ mol, Kanto Chemical Co., Ltd., purity of 99.0% or more) was dissolved in 10 mL of distilled water, and 1.36 g of potassium hexacyanoferrate(II) trihydrate (4.56×10⁻³ mol, Kanto Chemical Co., Ltd., purity of 99.5% or more) was dissolved in 10 mL of distilled water, and the mixture was stirred for 1 hour. Then, after centrifugation (4000 rpm, 2600×g, 15 minutes), the mixture was washed 10 times with distilled water, and dried under reduced pressure to obtain ZnPBA powder. The resulting ZnPBA powder had a composition of K_{0.65}Zn_{1.74}[Fe(CN)₆]·3.81H₂O and a theoretical capacity of 63.9 Ah/g.

### Preparation of ZnPBA Dispersion Liquid

To 0.29 g of the obtained ZnPBA powder, 5 mL of an aqueous solution of 5.1 mol % of sodium hexacyanoferrate(II) decahydrate of the total metal amount of ZnPBA as a dispersant was added, and the mixture was stirred for 2 weeks to obtain a dispersion liquid of sodium-containing ZnPBA. The resulting sodium-containing ZnPBA had a composition of Na_{0.16}K_{0.65}Zn_{1.74}[Fe(CN)₆]_{1.04}·3.81H₂O and a theoretical capacity of 64.5 mAh/g. The sodium-containing ZnPBA has a structure in which ferrocyanide ions are coordinated to a metal located on the surface of ZnPBA.

### Analysis of ZnPBA Dispersion Liquid

The obtained 5.1 mol % coated ZnPBA dispersion liquid was subjected to dynamic light scattering measurement and zeta potential measurement (Otsuka Electronics Co., Ltd., ELSZ-2000).

FIG. 1 shows the particle size (diameter) distribution of ZnPBA by dynamic light scattering measurement as a solid line. Since the particle diameter in the dispersion liquid is about 150 to 200 nm and the single crystal size of ZnPBA is about 150 to 200 nm, it can be seen that a substantially monodisperse ZnPBA dispersion liquid was obtained.

From the zeta potential measurement, the ZnPBA particles had a negative charge of −46.7 mV. It can be seen that the ZnPBA particles, having a large surface charge, repelled each other, which prevented aggregation and achieved high dispersion.

### Preparation of ZnPBA Binder-Free Electrode

The obtained ZnPBA dispersion liquid and a single-walled carbon nanotube (SWNT) dispersion liquid (0.4 wt %, KJ Special Paper Co., Ltd., TB004M) were mixed with each other in an amount such that the SWNT content was 3.0 wt % and the ZnPBA loading amount was 1.0 mg/cm², thereby obtaining a mixed liquid. The amount of SWNT is the ratio of the mass of SWNT to the total mass of SWNT and ZnPBA.

FIG. 19 shows an SEM image obtained by observing the fabricated electrode from the surface. The particles surrounded by a solid line were determined as primary particles, the particles surrounded by a broken line were determined as aggregated particles, and the ratio of the number of primary particles to the number of all particles of the active material particles was calculated based on the above formula (1). The ratio of the number of primary particles was 87%.

The resulting mixed liquid was filtered by suction onto a PTFE membrane filter (pore size: 0.1 μm, HPW-010-30, Sumitomo Electric Industries, Ltd.) and heated at 120° C. to obtain a ZnPBA binder-free electrode.

### Preparation of Negative Electrode

Zn foil (0.1 mm thick, Takeuchi Metal Foil & Powder Co., Ltd., 99.99%) was polished with water-resistant abrasive paper (Sankyo Rikagaku, #1500) to prepare a counter electrode (negative electrode).

### Preparation of Electrolytic Solution

An electrolyte solution was prepared by mixing 4M sodium trifluoromethanesulfonate (NaOTf) (Tokyo Chemical Industry Co., Ltd.) and 1M zinc trifluoromethanesulfonate (Zn(OTf)₂) (Tokyo Chemical Industry Co., Ltd.) with a mixed solvent of propylene carbonate (Kanto Chemical Co., Ltd.) and distilled water (propylene carbonate:distilled water=7:3).

### Production of Secondary Battery

Using the prepared ZnPBA binder-free electrode as the positive electrode, the prepared negative electrode, the prepared electrolyte solution, the PTFE membrane filter used for the filtration formation of the electrode as the separator, and carbon paper (Mitsubishi Chemical Corporation, MFO) as the current collector, an ion secondary battery was produced in which intercalation and deintercalation of Na⁺ in the positive electrode and dissolution/deposition of Zn²⁺ in the negative electrode served as the driving forces.

### Examples 2 to 7

A secondary battery was produced in the same manner as in Example 1, except that the amount of SWNTs was 0.1 wt %, 0.5 wt %, 1.0 wt %, 1.5 wt %, 5.0 wt %, and 10.0 wt %.

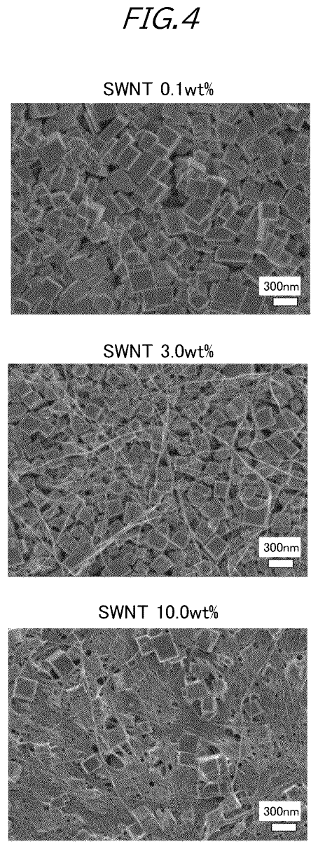

FIG. 4 shows scanning electron microscope (SEM) images (JSM-7600F, JEOL Ltd.) of ZnPBA binder-free electrodes with different amounts of SWNTs. FIG. 4 shows scanning electron microscope images of ZnPBA binder-free electrodes containing 0.1 wt %, 3.0 wt %, and 10.0 wt % SWNTs produced in Examples 1, 2, and 7. From FIG. 4, it can be clearly seen that when the amount of SWNTs is 0.1 to 3 wt %, most of the active material particles of ZnPBA are present in the primary particles, and linear SWNTs are stretched over the ZnPBA primary particles. Even when the amount of SWNTs was 10 wt %, most of the active material particles of ZnPBA were present in the primary particles, but the area ratio occupied by SWNTs was large, and the primary particles of ZnPBA were buried in the SWNTs.

### Occupied Area Ratio of Primary Particles

Using the SEM images of FIG. 4 and the following formula (4), the occupied area ratio of the primary particles of ZnPBA in the electrode when the amount of SWNTs was changed was determined. Table 1 shows the area occupancy of the primary particles of ZnPBA in the ZnPBA binder-free electrodes containing 0.1-10 wt % SWNTs prepared in Examples 1, 2, 6, and 7. The primary particles are non-agglomerated particles that can clearly recognize the contour in the SEM photograph.

Occupied area ratio (%)=[(Area of primary particles present)/(Observed area)]×100 (4).

TABLE 1
Occupied area ratio of primary ZnPBA
particles with varying SWNTs amount

| | Example 2 | Example 1 | Example 6 | Example 7 |
|---|---|---|---|---|
| SWNT amount (wt %) | 0.1 | 3.0 | 5.0 | 10.0 |
| Occupied area ratio (%) | 93 | 88 | 87 | 34 |

When the amount of SWNTs was 0.1-3 wt %, the individual ZnPBA particles could be clearly identified, and the ZnPBA primary particles showed the occupied area ratio of about 90%. When the amount of SWNTs was 10 wt %, the ZnPBA primary particles could also be clearly identified, but the area ratio occupied by SWNTs was large, and the occupied area ratio of the ZnPBA primary particles was 34%.

### Examples 8 to 14

A secondary battery was produced in the same manner as in Example 1, except that the concentrations of NaOTf and Zn(OTf)₂ in the electrolytic solution were 0.1 M, 0.2 M, 0.3 M, 0.5 M, 0.6 M, 0.7 M, and 0.8 M.

### Example 15

A secondary battery was produced in the same manner as in Example 1, except that the concentrations of NaOTf and Zn(OTf)₂ in the electrolyte solution were 1 M, respectively, and a mixed solvent of propylene carbonate (hereinafter, also referred to as PC) and distilled water (hereinafter, also referred to as water) (propylene carbonate:distilled water=9:1) was used.

### Example 16

A secondary battery was produced in the same manner as in Example 1, except that the concentration of NaOTf in the electrolyte was 2 M, the concentration of Zn(OTf)₂ was 1 M, and a mixed solvent of propylene carbonate and distilled water (propylene carbonate:distilled water=9:1) was used.

### Examples 17 to 19

A secondary battery was produced in the same manner as in Example 5, except that the loading amount of the active material was 0.75 mg/cm², 0.5 mg/cm², and 0.25 mg/cm². The loading amount of the active material was obtained by reducing the mixing amount of the ZnPBA dispersion liquid and SWNT dispersion liquid, which were the same as those used in Example 5, to 75%, 50%, and 25%, respectively, while maintaining the mixing ratio.

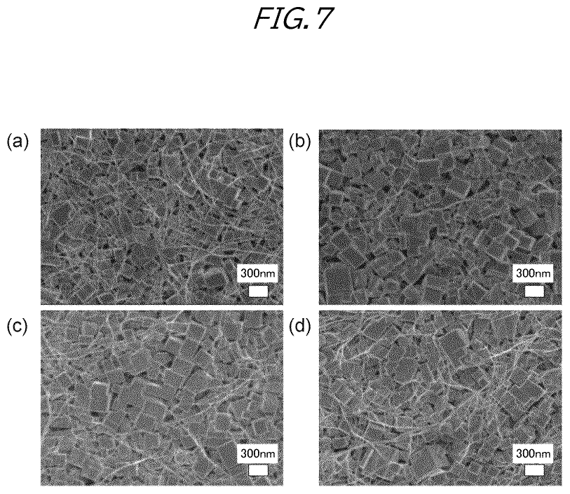

FIG. 7 shows scanning electron microscope (SEM) images obtained by observing electrodes having different amounts of the active material supported by the ZnPBA produced in Examples 5 and 17 to 19 from the surface. FIG. 7 shows SEM images of ZnPBA binder-free electrodes with active material loadings of (a) 0.25 mg/cm², (b) 0.5 mg/cm², (c) 0.75 mg/cm², and (d) 1.0 mg/cm². FIG. 21 shows scanning electron microscope (SEM) images obtained by observing the cross sections of the electrodes with different loading amounts described above. In the electrodes with different active material loading amounts, as shown in FIG. 21, the electrode thickness was changed according to the loading amount, but as shown in FIG. 7, there was no difference in the composite structure of the active material particles and the SWNTs due to the active material loading amount, most of the ZnPBA particles were present as primary particles, and there was no difference in the dispersibility of the ZnPBA particles.

### Example 20

A secondary battery was produced in the same manner as in Example 19, except that the concentration of NaOTf in the electrolyte was 2 M, the concentration of Zn(OTf)₂ was 1 M, and a mixed solvent of propylene carbonate and distilled water (propylene carbonate:distilled water=9:1) was used.

### Example 21

A secondary battery was produced in the same manner as in Example 15, except that the amount of dispersant was 13.7 mol %.

### Comparative Example 1

A secondary battery was prepared in the same manner as in Example 1, except that the SWNT amount was 0.05 wt %.

### (Comparative Example 2) Preparation of ZnPBA Binder-Free Electrode Using Suspension and Battery Characteristics

### Preparation of ZnPBA Suspension

To 0.29 g of ZnPBA powder obtained in the same manner as in Example 1, 20 mL of distilled water was added, and the mixture was treated with a sonicator (ASONE, MCD-2P) for 1 hour to obtain a ZnPBA suspension.

### Analysis of ZnPBA Suspension

The obtained ZnPBA suspension was subjected to dynamic light scattering measurement and zeta potential measurement (ELSZ-2000, Otsuka Electronics Co., Ltd.).

FIG. 1 shows the particle size (diameter) distribution of ZnPBA by dynamic light scattering measurement in a broken line. The ZnPBA particles had a negative charge of −23.1 mV, but the mutual repulsive force was small, the particle size was distributed over 400 to more than 10000 nm, and aggregates were present.

### Preparation of ZnPBA Binder-Free Electrode

The obtained ZnPBA suspension and a single-walled carbon nanotube (SWNT) dispersion liquid (0.4 wt %, KJ Special Paper Co., Ltd., TB004M) were mixed in an amount such that the SWNT content was 3.0 wt % and the ZnPBA loading amount was 1.0 mg/cm² to obtain a mixed liquid.

FIG. 20 shows an SEM image obtained by observing the produced electrode from the surface. The particles surrounded by a solid line were determined as primary particles, the particles surrounded by a broken line were determined as aggregated particles, and the ratio of the number of primary particles to the number of all particles of the active material particles was calculated based on the above formula (1). The ratio of the number of primary particles was 22%.

The resulting mixed liquid was filtered by suction onto a PTFE membrane filter (pore size: 0.1 μm, HPW-010-30, Sumitomo Electric Industries, Ltd.) and heated at 120° C. to obtain a ZnPBA binder-free electrode. The obtained electrode was used to produce a secondary battery in the same manner as in Example 15.

### (Comparative Example 3) Preparation of Electrode Containing ZnPBA Binder and Battery Characteristics

### Isolation of Surface-Coated ZnPBA

The ZnPBA (5.1 mol %) dispersion liquid prepared in Example 1 was centrifuged (15000 rpm, 22400×g, 10 minutes) to isolate the ZnPBA powder.

### Preparation of Binder-Containing Electrode

21 mg of the isolated ZnPBA powder, 3.0 mg of polyvinylidene fluoride (PVDF, SigmaAldrich, weight-average molecular weight Mw approximately 523,000), 6.3 mg of SuperP (MTI corporation) as particulate conductive carbon particles, and 200 μL of 1-methyl-2-pyrrolidone (SigmaAldrich) were mixed and mixed for 4 hours using an automated mortar (AMM-140D, Nitto Kagaku Co., Ltd.) to obtain a paste. The mass ratio of ZnPBA:SuperP:PVDF was 7:2:1. The obtained paste was applied to carbon paper and dried by heating (120° C. for 1 hour) to prepare a binder-containing ZnPBA electrode. The obtained electrode was used to produce a secondary battery in the same manner as in Example 15. The loading amount of ZnPBA was 1.0 mg/cm².

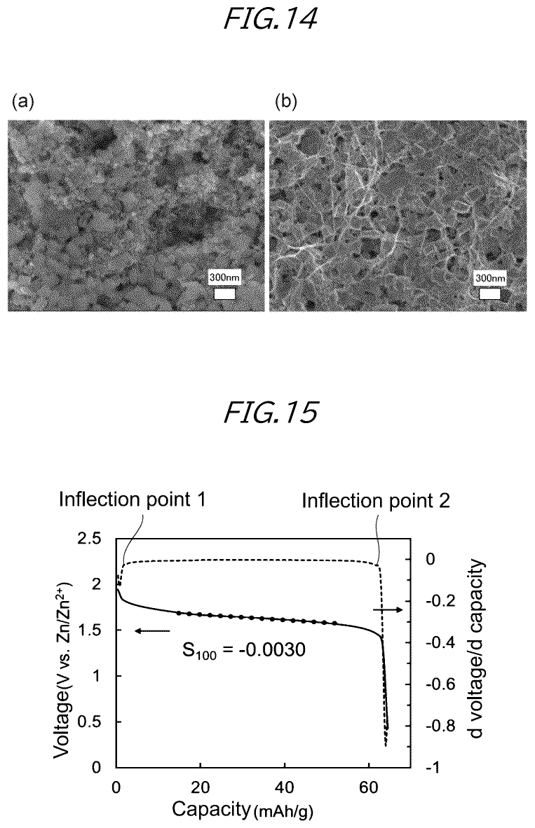

FIG. 14 shows SEM images of (a) the binder-containing ZnPBA electrode prepared in Comparative Example 3, and (b) an SEM image of the ZnPBA binder-free electrode using the ZnPBA suspension prepared in Comparative Example 2. In the binder-containing ZnPBA electrode of Comparative Example 3, the particulate conductive carbon particles and the ZnPBA particles were segregated and separated from each other. In the ZnPBA binder-free electrode using the ZnPBA suspension of Comparative Example 2, aggregates of ZnPBA were observed, and this result is consistent with the result of the dynamic light scattering measurement (broken line in FIG. 1).

According to the above formula (4), the occupied area ratio of the primary particles in the electrodes prepared in Comparative Examples 2 and 3 was determined. Table 2 shows the occupied area ratio of the primary particles of ZnPBA in the electrodes prepared in Comparative Examples 2 and 3.

The binder-containing electrode of Comparative Example 3 had relatively good dispersibility since it included a dispersing step and a kneading step by surface treatment, and had an occupied area ratio of the primary particles of 37.5%. On the other hand, in the binder-free electrode of Comparative Example 2 prepared using the ZnPBA suspension not including the dispersion step and the kneading step, aggregation of the ZnPBA particles occurred remarkably, and the occupied area ratio of the primary particles was 8.4%.

TABLE 2
Occupied area ratio of FeZnPBA primary particles in the
electrodes prepared in Comparative Examples 2 and 3

| | Occupied area ratio (%) |
|---|---|
| Comparative Example 2 | 8.4 |
| Binder-free electrode (suspension) | |
| Comparative Example 3 | 37.5 |
| Binder-containing electrode | |

The battery characteristics of the secondary batteries produced in respective Examples were evaluated using a potentiostat/galvanostat analyzer ECstat-302 manufactured by EC Frontier Co., Ltd. as the charge and discharge device, and SB9 manufactured by EC Frontier Co., Ltd. as the charge and discharge evaluation cell.

### Battery Capacity by Dispersant

The secondary battery produced in Comparative Example 2 without the addition of a dispersant had a capacity of 63% of the theoretical capacity at 100 C, whereas the secondary batteries produced in Example 15 and Example 21 with the addition of the dispersant had capacities of 86% and 87% of the theoretical capacity at 100 C, respectively. The battery capacity (hereinafter, also referred to as capacity) is capacity per unit mass of the positive electrode active material.

### Battery Characteristics by SWNT Amount

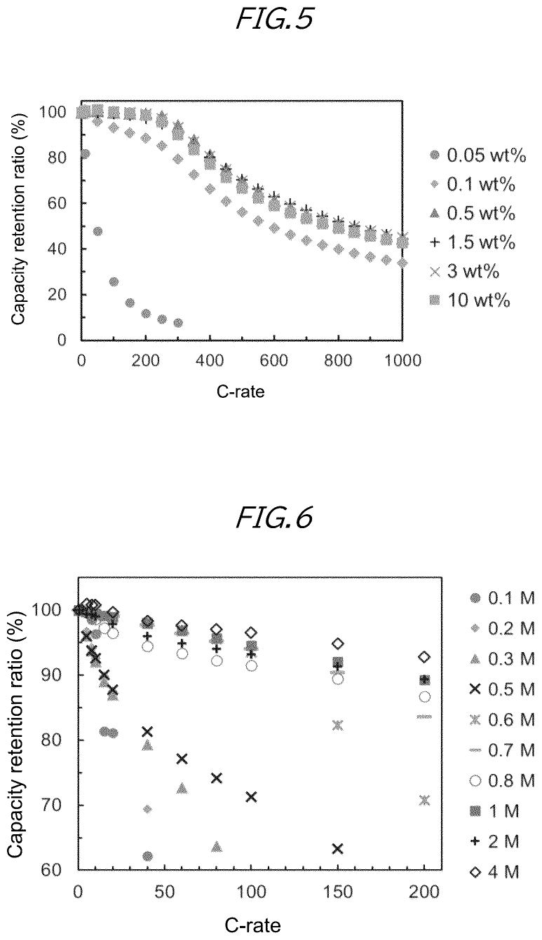

The charge and discharge characteristics (C-rate characteristics) of the ZnPBA binder-free electrodes depending on the amount of SWNTs were measured. FIG. 5 is a graph showing the relationship between the capacity retention rate and the C-rate of the secondary batteries produced using the ZnPBA binder-free electrodes containing 0.05 wt %, 0.1 wt %, 0.5 wt %, 1.5 wt %, 3.0 wt %, and 10.0 wt % of SWNTs prepared in Comparative Example 1, and Examples 1 to 3, 5, and 7. The capacity retention ratio is a ratio of the capacity when the C-rate is changed based on the capacity at 1 C.

Good C-rate characteristics were obtained when the amount of SWNTs was 0.1 wt % or more, better C-rate characteristics were obtained when the amount of SWNTs was 0.5 wt % or more, and even better C-rate characteristics were obtained when the amount of SWNTs was 1.5 to 3.0 wt %. It was shown that the balance between the electron conductivity and the ion conductivity was good when the amount of SWNTs was in the above range.

At 1 C, the battery having the smallest capacity was the battery produced in Comparative Example 1 in which the amount of SWNTs was 0.05 wt % and exhibited a capacity of 56.6 mAh/g (87.7% of the theoretical capacity). The battery having the largest capacity was the battery produced in Example 7 in which the amount of SWNTs was 10 wt %, and exhibited a capacity of 69.6 mAh/g (108.2% of the theoretical capacity) at 1 C. The reason why the capacity exceeds 100% of the theoretical capacity is that, as described above, there is a difference between the design value of the loading amount of the active material and the loading amount of the active material when the electrode is actually prepared (hereinafter, the same applies).

### Battery Capacity Change Depending on Electrolyte Concentration

The battery capacity of the secondary batteries produced by changing the electrolyte concentration in Examples 1 and 8 to 16 was evaluated. At the concentrations ranging from 0.1M to 0.8M, the solvents are propylene carbonate only and the concentrations of NaOTf and Zn(OTf)₂ are the same. The concentration of 1M is obtained by dissolving 1M Na(OTf) and 1M Zn(OTf)₂ in a mixed solvent of propylene carbonate and distilled water (propylene carbonate:distilled water=9:1). The concentration of 2M is obtained by dissolving 2M Na(OTf) and 1M Zn(OTf)₂ in a mixed solvent of propylene carbonate and distilled water (propylene carbonate:distilled water=9:1). The concentration of 4M is obtained by dissolving 4M Na(OTf) and 1M Zn(OTf)₂ in a mixed solvent of propylene carbonate and distilled water (propylene carbonate:distilled water=7:3).

FIG. 6 is a graph showing the relationship between the C-rate and the capacity retention ratio depending on the concentration of the electrolytic solution. The graph of FIG. 6 shows the relative capacity with the capacity at 1 C being 100%. As the concentration of the electrolyte solution increased, the C-rate characteristics improved. It is considered that the higher the concentration of the electrolyte solution, the higher the ion concentration in the vicinity of the active material particles, and therefore, the diffusion distance of the ions became shorter, and the ions could be smoothly exchanged.

The battery with the largest capacity at 1 C was the battery with the concentration of the electrolyte solution of 4M prepared in Example 1, which exhibited a capacity of 75.7 mAh/g (117.3% of the theoretical capacity), and the battery with the smallest capacity at 1 C was the battery with the concentration of the electrolyte solution of 0.1M prepared in Example 8, which exhibited a capacity of 70.0 mAh/g (108.5% of the theoretical capacity).

### Influence of Active Material Loading on Battery Characteristics

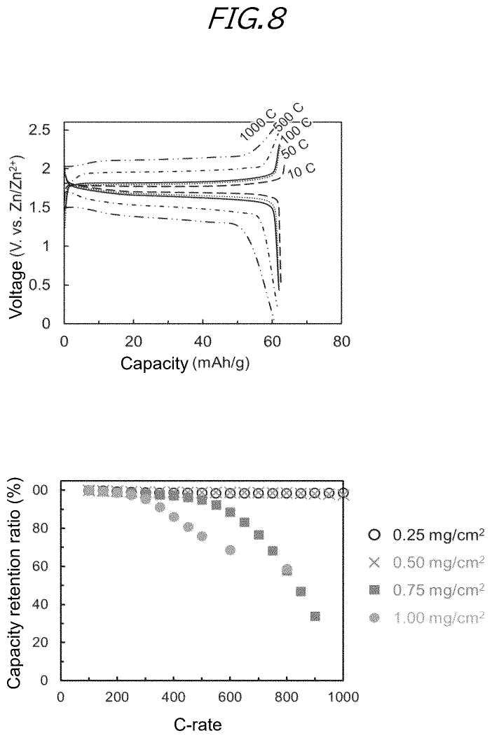

The secondary batteries produced in Examples 5 and 17 to 19 had capacities of 97.6%, 95.6%, 96.2%, and 93.8% of the theoretical capacity at 1 C, respectively, and exhibited a substantially the same capacity. These secondary batteries also exhibited substantially the same capacity even at 100 C. FIG. 8 shows the charge-discharge curves of the secondary batteries produced in Example 18 and the C-rate characteristics of the secondary batteries produced in Examples 5 and 17 to 19. The secondary battery produced in Example 18 showed a capacity of 61.5 mAh/g at 1 C, which was 95.3% of the theoretical capacity (64.5 mAh/g). Even when the C-rate was increased, the battery capacity showed a gradual decrease, and even at 1000 C, a high capacity of 60.6 mAh/g was shown, and a clear plateau region with a slope of −0.0032 was shown. In the secondary batteries with active material loadings of 0.5 mg/cm² and 0.25 mg/cm², the capacity retention ratio exceeded 90% up to 1000 C. The smaller the loading amount of the active material is, the higher the C-rate characteristics are, and this is because the response rate of Zn²⁺ dissolution/precipitation of the metal-zinc plate as the counter electrode is rate-limiting.

### Cycle Characteristics (Durability)

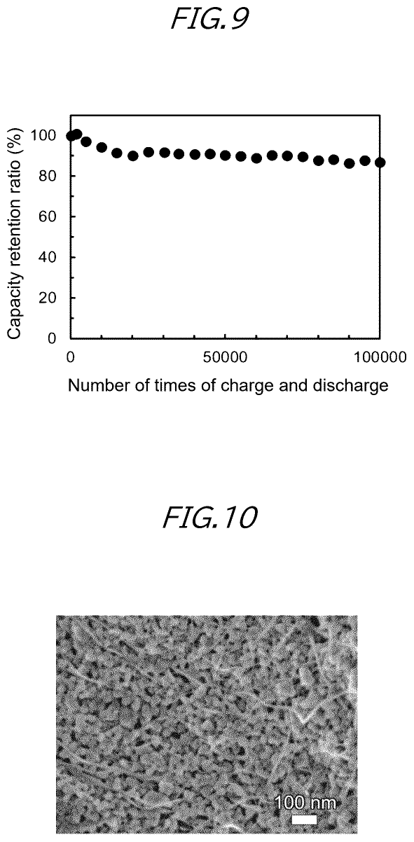

The secondary battery produced in Example 20 was evaluated for cycle characteristics of up to 100000 cycles at 400 C. FIG. 9 shows the capacity retention rate depending on the number of cycles (the number of times of charge and discharge). The produced secondary battery showed a capacity of 62.9 mAh/g at 200 cycles, which was 97.5% of the theoretical capacity (64.5 mAh/g). Even after 50000 cycles or more of charging and discharging, it exhibited a capacity of 90% or more of the initial capacity, and even after 100000 cycles of charging and discharging, it had a capacity of 85% or more of the initial capacity, demonstrating excellent cycle characteristics.

### Evaluation of Battery Characteristics Affected by Presence or Absence of Binder and Dispersibility of Active Material

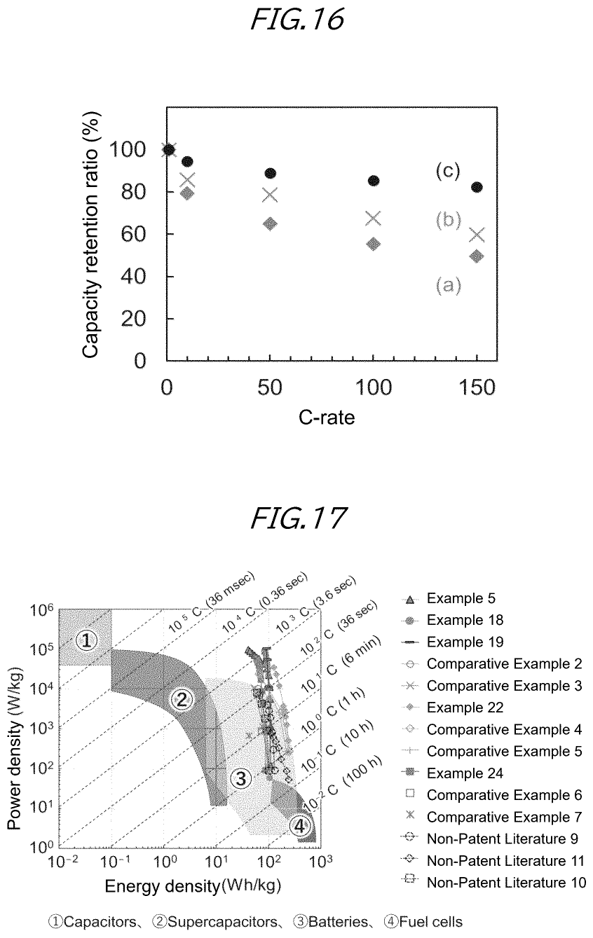

FIG. 16 shows C-rate characteristics (capacity retention ratio) of (a) the secondary battery including the binder-containing electrode of Comparative Example 3, (b) the secondary battery including the binder-free electrode prepared using the active material suspension in Comparative Example 2, and (c) the secondary battery produced in Example 15. The secondary battery (a) provided with the binder-containing electrode of Comparative Example 3 exhibited a battery capacity as low as about 50% of the capacity at 1 C when charged and discharged at 100 C, and the battery capacity greatly decreased with an increase in the C-rate. The secondary battery (b) provided with the binder-free electrode prepared using the active material suspension in Comparative Example 2 also exhibited a low battery capacity of about 63% of the capacity at 1 C when charged and discharged at 100 C, and the battery capacity decreased with an increase in the C-rate. The secondary battery (c) provided with the binder-free electrode prepared in Example 15 exhibited a high battery capacity of about 86% of the capacity at 1 C when charged and discharged at 100 C, and exhibited excellent C-rate characteristics.

Table 3-1 and Table 3-2 show the production conditions of the secondary battery including the amount of dispersant, the amount of SWNTs, the loading amount of active material, and the electrolyte concentration as well as the ratio of the number of primary particles, the energy density (Wh/kg) when the power density is 10000 (W/kg), and the capacity retention ratio (%) when the energy density of 60 Wh/kg or more and the power density of 10000 W/kg are obtained, in Examples 1 to 21 and Comparative Examples 1 to 3. For the column of energy density (Wh/kg) when the power density was 30000 W/kg, those for which the power density did not reach 30000 W/kg are indicated as [-]. For the column of the capacity retention ratio (%) when obtaining an energy density of 60 Wh/kg or more and a power density of 10000 W/kg or more, [-] is displayed when the capacity retention ratio is less than 60%.

TABLE 3-1
production conditions, composition, and characteristics of secondary
batteries in Examples 1-21 and Comparative Examples 1-3

| | | | | | | | Capacity |
|---|---|---|---|---|---|---|---|
| | | | | | | | Retention (%) |
| | | | | | | Energy Density | When Achieving |
| | | | Active | | | at Power | Energy Density ≥60 |
| | Dispersant | SWNT | Material | Electrolyte | Primary | Density of | Wh/kg and Power |
| | Amount | Amount | Loading | Concentration | Particle | 30,000 W/kg | Density ≥10,000 |
| | (mol %) | (wt %) | (mg/cm²) | (mol/L) | Ratio (%) | (Wh/kg) | W/kg |
| Example 1 | 5.1 | 3.0 | 1.0 | NaOTf:4M | 87 | 93 | 100 |
| | | | | Zn(OTf)₂:1M | | | |
| | | | | PC:water = 7:3 | | | |
| Example 2 | 5.1 | 0.1 | 1.0 | NaOTf:4M | 90 | 83 | 93 |
| | | | | Zn(OTf)₂:1M | | | |
| | | | | PC:water = 7:3 | | | |
| Example 3 | 5.1 | 0.5 | 1.0 | NaOTf:4M | 90 | 89 | 101 |
| | | | | Zn(OTf)₂:1M | | | |
| | | | | PC:water = 7:3 | | | |
| Example 4 | 5.1 | 1.0 | 1.0 | NaOTf:4M | 90 | 89 | 100 |
| | | | | Zn(OTf)₂:1M | | | |
| | | | | PC:water = 7:3 | | | |
| Example 5 | 5.1 | 1.5 | 1.0 | NaOTf:4M | 90 | 88 | 99 |
| | | | | Zn(OTf)₂:1M | | | |
| | | | | PC:water = 7:3 | | | |
| Example 6 | 5.1 | 5.0 | 1.0 | NaOTf:4M | 90 | 90 | 100 |
| | | | | Zn(OTf)₂:1M | | | |
| | | | | PC:water = 7:3 | | | |
| Example 7 | 5.1 | 10.0 | 1.0 | NaOTf:4M | 91 | 95 | 100 |
| | | | | Zn(OTf)₂:1M | | | |
| | | | | PC:water = 7:3 | | | |
| Example 8 | 5.1 | 3.0 | 1.0 | NaOTf:0.1M | 87 | — | — |
| | | | | Zn(OTf)₂:0.1M | | | |
| | | | | PC | | | |
| Example 9 | 5.1 | 3.0 | 1.0 | NaOTf:0.2M | 87 | — | — |
| | | | | Zn(OTf)₂:0.2M | | | |
| | | | | PC | | | |
| Example 10 | 5.1 | 3.0 | 1.0 | NaOTf:0.3M | 87 | — | — |
| | | | | Zn(OTf)₂:0.3M | | | |
| | | | | PC | | | |

TABLE 3-2
Production conditions, composition, and characteristics of secondary
batteries in Examples 1-21 and Comparative Examples 1-3

| | | | | | | | Capacity |
|---|---|---|---|---|---|---|---|
| | | | | | | | Retention (%) |
| | | | | | | Energy Density | When Achieving |
| | | | Active | | | at Power | Energy Density ≥60 |
| | Dispersant | SWNT | Material | Electrolyte | Primary | Density of | Wh/kg and Power |
| | Amount | Amount | Loading | Concentration | Particle | 30,000 W/kg | Density ≥10,000 |
| | (mol %) | (wt %) | (mg/cm²) | (mol/L) | Ratio (%) | (Wh/kg) | W/kg |
| Example 11 | 5.1 | 3.0 | 1.0 | NaOTf:0.5M | 87 | — | 63 |
| | | | | Zn(OTf)₂:0.5M | | | |
| | | | | PC | | | |
| Example 12 | 5.1 | 3.0 | 1.0 | NaOTf:0.6M | 87 | — | 82 |
| | | | | Zn(OTf)₂:0.6M | | | |
| | | | | PC | | | |
| Example 13 | 5.1 | 3.0 | 1.0 | NaOTf:0.7M | 87 | 48 | 90 |
| | | | | Zn(OTf)₂:0.7M | | | |
| | | | | PC | | | |
| Example 14 | 5.1 | 3.0 | 1.0 | NaOTf:0.8M | 87 | 67 | 89 |
| | | | | Zn(OTf)₂:0.8M | | | |
| | | | | PC | | | |
| Example 15 | 5.1 | 3.0 | 1.0 | NaOTf:1M | 87 | 72 | 92 |
| | | | | Zn(OTf)₂:1M | | | |
| | | | | PC:water = 9:1 | | | |
| Example 16 | 5.1 | 3.0 | 1.0 | NaOTf:2M | 87 | 84 | 91 |
| | | | | Zn(OTf)₂:1M | | | |
| | | | | PC:water = 9:1 | | | |
| Example 17 | 5.1 | 1.5 | 0.75 | NaOTf:4M | 89 | 96 | 100 |
| | | | | Zn(OTf)₂:1M | | | |
| | | | | PC:water = 7:3 | | | |
| Example 18 | 5.1 | 1.5 | 0.5 | NaOTf:4M | 87 | 97 | 100 |
| | | | | Zn(OTf)₂:1M | | | |
| | | | | PC:water = 7:3 | | | |
| Example 19 | 5.1 | 1.5 | 0.25 | NaOTf:4M | 85 | 97 | 100 |
| | | | | Zn(OTf)₂:1M | | | |
| | | | | PC:water = 7:3 | | | |
| Example 20 | 5.1 | 1.5 | 0.25 | NaOTf:2M | 85 | 92 | 98 |
| | | | | Zn(OTf)₂:1M | | | |
| | | | | PC:water = 9:1 | | | |
| Example 21 | 13.7 | 3.0 | 1.0 | NaOTf:1M | 90 | 73 | 92 |
| | | | | Zn(OTf)₂:1M | | | |
| | | | | PC | | | |
| Comparative | 5.1 | 0.05 | 1.0 | NaOTf:4M | 90 | — | — |
| Example 1 | | | | Zn(OTf)₂:1M | | | |
| | | | | PC:water = 7:3 | | | |
| Comparative | 0 | 3.0 | 1.0 | NaOTf:1M | 22 | — | 68 |
| Example 2 | | | | Zn(OTf)₂:1M | | | |
| (Suspension) | | | | PC:water = 9:1 | | | |
| Comparative | 5.1 | SuperP | 1.0 | NaOTf:1M | 63 | — | — |
| Example 3 | | | | Zn(OTf)₂:1M | | | |
| (with Binder) | | | | PC:water = 9:1 | | | |

### Example 22

### Preparation of MnPBA Binder-Free Electrode and its Battery Characteristics

### Synthesis of MnPBA

1.47 g (6.00×10⁻³ mol, Kanto Chemical Co., Ltd., purity 99.0% or more) of zinc acetate tetrahydrate was dissolved in 10 mL of distilled water, and 1.27 g (3.00×10⁻³ mol, Kanto Chemical Co., Ltd., purity 99.5% or more) of potassium hexacyanoferrate(II) trihydrate was dissolved in 50 mL of distilled water, and the mixture was stirred for 1 hour. Then, after centrifugation (4000 rpm, 2600×g, 15 minutes), the mixture was washed 10 times with distilled water and dried under reduced pressure to obtain MnPBA powder. The resulting MnPBA powder had a composition of K_{1.65}Mn_{1.22}[Fe(CN)₆]·1.35H₂O. The theoretical capacity was 153.43 mAh/g.

### Preparation of MnPBA Dispersion Liquid

To 0.10 g of the obtained MnPBA powder, 5 mL of an aqueous solution of 0.054 g (2.75×10⁻⁴ mol) of 21 mol % of potassium hexacyanoferrate(II) trihydrate of the total metal amount of MnPBA was added as a dispersant, and the mixture was stirred for 2 weeks to obtain a potassium-containing MnPBA dispersion liquid. The resulting potassium-containing MnPBA had a composition of K_{1.84}Mn_{1.12}[Fe(CN)₆]·1.24H₂O and a theoretical capacity of 154.50 mAh/g. The potassium-containing MnPBA has a structure in which ferrocyanide ion is coordinated to a metal located on the surface of MnPBA.

### Preparation of MnPBA Binder-Free Electrode

The obtained MnPBA dispersion liquid and a single-walled carbon nanotube (SWNT) dispersion liquid (0.4 wt %, KJ Special Paper Co., Ltd., TB004M) were mixed to obtain a mixed liquid. The amount of SWNTs was 2.6 wt %.

The resulting mixed liquid was filtered by suction onto a PTFE membrane filter (pore size: 0.1 μm, HPW-010-30, Sumitomo Electric Industries, Ltd.) and heated at 120° C. to obtain a MnPBA binder-free electrode. The MnPBA loading amount of the resulting MnPBA electrode was 0.5 mg/cm².

### Preparation of Negative Electrode

A Zn foil (0.1 mm thick, Takeuchi Metal Foil & Powder Co., Ltd., 99.99%) polished with water-resistant abrasive paper (Sankyo Rikagaku, #1500) was used as the negative electrode.

### Preparation of Electrolytic Solution

An electrolyte solution was prepared by dissolving 2M potassium trifluoromethanesulfonate (K(OTf)) (Tokyo Chemical Industry Co., Ltd.) and 1M Zn(OTf)₂ (Tokyo Chemical Industry Co., Ltd.) as electrolytes in a mixed solution (volume ratio 9:1) of propylene carbonate (Kanto Chemical Co., Ltd.) and distilled water as solvents.

### Production of Secondary Battery

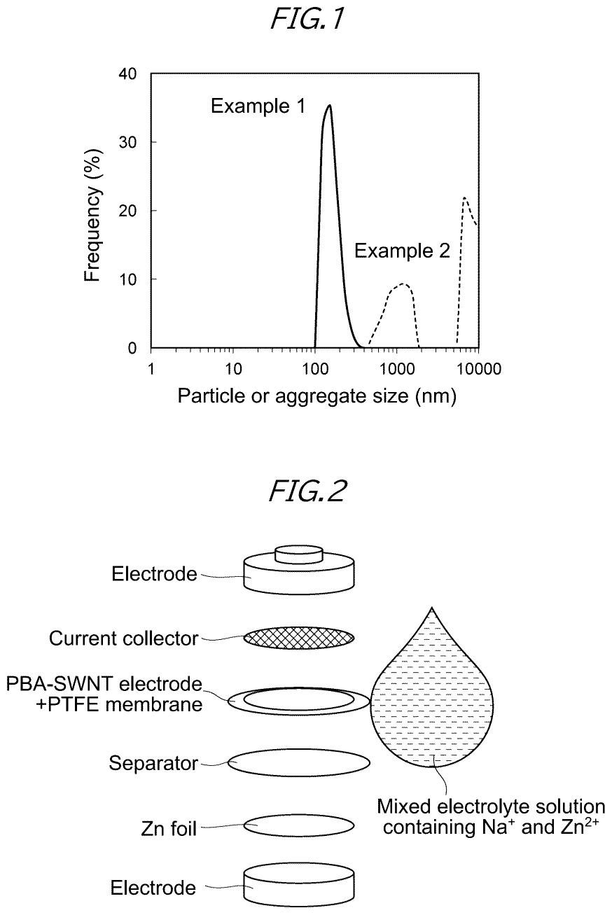

Using the prepared MnPBA binder-free electrode as the positive electrode, the prepared negative electrode, the prepared electrolyte solution, the PTFE membrane filter used for the filtration formation of the electrode as the separator, and carbon paper (Mitsubishi Chemical Corporation, MFO) as the current collector, an ion secondary battery was produced in which intercalation and deintercalation of K⁺ in the positive electrode and dissolution/deposition of Zn²⁺ in the negative electrode served as the driving forces. FIG. 2 is a schematic diagram of the configuration of the secondary battery.

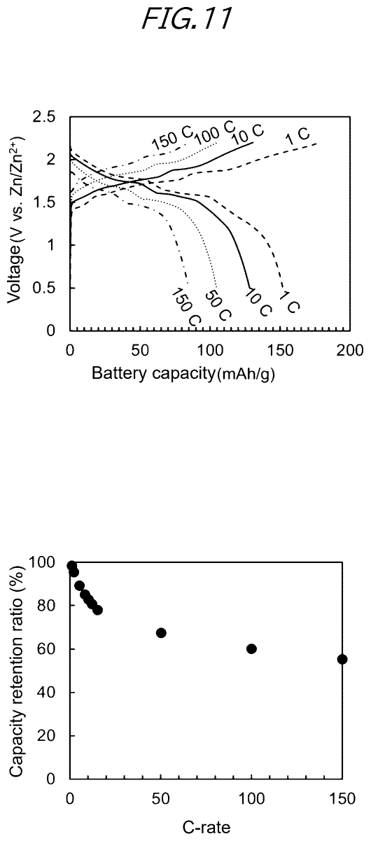

FIG. 10 shows an SEM image of the prepared MnPBA binder-free electrode. The MnPBA particles had an average particle size of about 30 nm, and the SWNTs were uniformly present throughout the field of view.

### Example 23

### Battery Combining MnPBA and Aqueous Electrolyte

### Preparation of Aqueous Electrolyte

A secondary battery was prepared in the same manner as in Example 22, except that a mixed ionic aqueous solution prepared by dissolving 2M K(OTf) and 1M Zn(OTf)₂ in distilled water as a solvent was used as the electrolyte.

### (Comparative Example 4) Preparation of MnPBA Binder-Free Electrode Using Suspension and Battery Characteristics

### Preparation of MnPBA Suspension

To 0.105 g of MnPBA powder obtained in the same manner as in Example 22, 5.0 mL of distilled water was added, and the mixture was treated with a sonicator (ASONE, MCD-2P) for 1 hour to obtain a MnPBA suspension.

### Preparation of MnPBA Binder-Free Electrode

The obtained MnPBA suspension was mixed with a single-walled carbon nanotube (SWNT) dispersion liquid (0.4 wt %, KJ Special Paper Co., Ltd., TB004M) to obtain a mixed liquid. The amount of SWNTs was 2.6 wt %.

The resulting mixed liquid was filtered by suction onto a PTFE membrane filter (pore size: 0.1 μm, HPW-010-30, Sumitomo Electric Industries, Ltd.) and heated at 120° C. to obtain a MnPBA binder-free electrode. The MnPBA loading amount of the resulting MnPBA electrode was 1.00 mg/cm². The obtained electrode was used to produce a secondary battery in the same manner as in Example 22.

### (Comparative Example 5) Preparation of MnPBA Binder-Containing Electrode and Battery Characteristics

### Preparation of Binder-Containing Electrode

21.0 mg of MnPBA powder obtained in the same manner as in Example 22, 3.0 mg of polyvinylidene fluoride (PVDF, SigmaAldrich, weight-average molecular weight Mw approximately 523,000), and 6.0 mg of SuperP (MTI corporation) as particulate conductive carbon particles, and 200 μL of 1-methyl-2-pyrrolidone (SigmaAldrich) were mixed and mixed for 4 hours using an automated mortar (AMM-140D, Nitto Kagaku Co., Ltd.) to obtain a paste. The mass ratio of MnPBA:SuperP:PVDF was 7:2:1. The obtained paste was applied to carbon paper and dried by heating (120° C. for 1 hour) to prepare a binder-containing MnPBA electrode. The loading amount of MnPBA was 1.0 mg/cm². The obtained electrode was used to produce a secondary battery in the same manner as in Example 22.

The battery characteristics of the secondary batteries produced in Examples 22 and 23 and Comparative Example 4 were evaluated using a potentiostat/galvanostat analyzer ECstat-302 manufactured by EC Frontier Co., Ltd. as the charge and discharge device, and SB9 manufactured by EC Frontier Co., Ltd. as the charge and discharge evaluation cell.

FIG. 11 shows the charge-discharge curve and C-rate characteristics of the secondary battery with the MnPBA binder-free electrode prepared in Example 22. The produced secondary battery showed a capacity of 153.00 mAh/g at 1 C, which was 99.1% of the theoretical capacity (154.32 mAh/g). When the C-rate was increased, the battery capacity decreased relatively greatly up to 50 C, and the capacity decreased gradually as the C-rate was increased in the range of 50 to 150 C. However, the capacity was higher than 100 mAh/g even at 100 C, and the capacity was as high as 85 mAh/g even at 150 C, and the slope (average value) showed a clear plateau region of −0.0040.

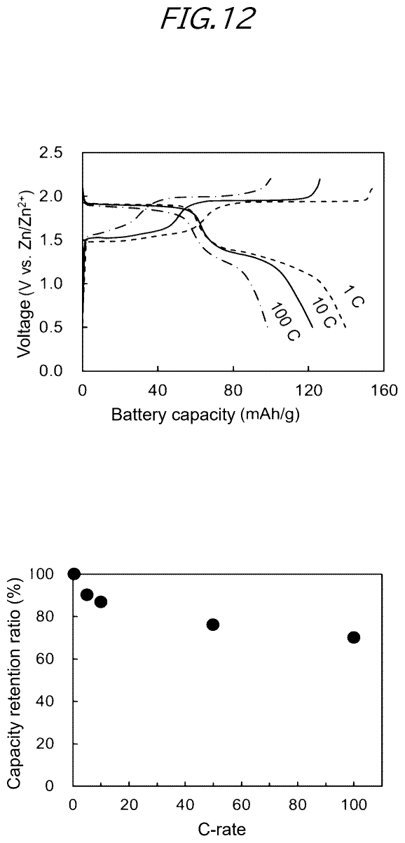

FIG. 12 shows charge and discharge characteristics of a secondary battery prepared using the MnPBA binder-free electrode prepared in Example 23 and an aqueous electrolyte solution. The produced secondary battery showed a capacity of 125.3 mAh/g at 1 C, which was 81.7% of the theoretical capacity (153.43 mAh/g). The produced secondary battery showed little capacity decrease even if the C-rate was increased, and showed a capacity retention ratio of 100 mAh/g or more and 70% at 100 C, and showed a plateau region with a slope (average value) of −0.0028 flat at 1 C to 100 C. That is, it was shown that the secondary battery produced by using the aqueous electrolytic solution produced in this Example can be charged and discharged at high speed.

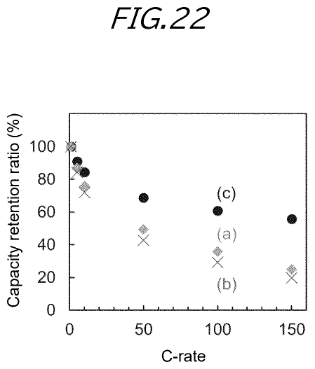

FIG. 22 shows C-rate characteristics (high-speed charge and discharge characteristics) of (a) the secondary battery including the binder-containing electrode of Comparative Example 5, (b) the secondary battery including the binder-free electrode prepared using the active material suspension in Comparative Example 4, and (c) the secondary battery produced in Example 22. In the secondary battery (a) including the binder-containing electrode of Comparative Example 5, the battery capacity significantly decreased with an increase in the C-rate. The battery capacity of the secondary battery (b) including the binder-free electrode prepared using the active material suspension in Comparative Example 4 also decreased with an increase in the C-rate. The secondary battery (c) including the binder-free electrode prepared in Example 22 showed excellent C-rate characteristics.

Table 4 shows the production conditions of the secondary battery including the amount of dispersant, the amount of SWNTs, the loading amount of active material, and the electrolyte concentration as well as the ratio of the number of primary particles, the energy density (Wh/kg) when the power density is 10000 (W/kg), and the capacity retention ratio (%) when the energy density of 60 Wh/kg or more and the power density of 10000 W/kg are obtained, in Examples 22 and 23 and Comparative Examples 4 and 5.

TABLE 4
Production conditions, composition, and characteristics of secondary
batteries in Examples 22-23 and Comparative Examples 4-5

| | | | | | | | Capacity |
|---|---|---|---|---|---|---|---|
| | | | | | | | Retention (%) |
| | | | | | | Energy Density | When Achieving |
| | | | Active | | | at Power | Energy Density ≥100 |
| | Dispersant | SWNT | Material | Electrolyte | Primary | Density of | Wh/kg and Power |
| | Amount | Amount | Loading | Concentration | Particle | 30,000 W/kg | Density ≥10,000 |
| | (mol %) | (wt %) | (mg/cm²) | (mol/L) | Ratio (%) | (Wh/kg) | W/kg |
| Example 22 | 21.0 | 2.6 | 0.5 | K(OTf):2M | 77 | 130 | 69 |
| | | | | Zn(OTf)₂:0.1M | | | |
| | | | | PC:water = 9:1 | | | |
| Example 23 | 21.0 | 2.6 | 0.5 | K(OTf):2M | 77 | 170 | 71 |
| | | | | Zn(OTf)₂:1M | | | |
| | | | | Water | | | |
| Comparative | 0 | 2.6 | 1 | K(OTf):1M | 37 | 30 | 49 |
| Example 4 | | | | Zn(OTf)₂:1M | | | |
| (Suspension) | | | | PC:water = 9:1 | | | |
| Comparative | 0 | Super P | 1 | K(OTf):1M | 20 | 20 | 50 |
| Example 5 | | | | Zn(OTf)₂:1M | | | |
| (with Binder) | | | | PC:water = 9:1 | | | |

### Example 24

### Preparation of CuPBA Binder-Free Electrode and its Battery Characteristics

### Synthesis of CuPBA

1.45 g of copper nitrate 3-hydrate (6.00×10⁻³ mol, Kanto Chemical Co., Ltd., purity 99.2% or more) was dissolved in 10 mL of distilled water, 1.27 g (3.00×10⁻³ mol, Kanto Chemical Co., Ltd., purity 99.5% or more) of potassium hexacyanoferrate(II) trihydrate was dissolved in 50 mL of distilled water, and the mixture was stirred for 1 hour. Then, after centrifugation (4000 rpm, 2600×g, 15 minutes), the mixture was washed 10 times with distilled water and dried under reduced pressure to obtain CuPBA powder. The resulting CuPBA powder had a composition of K_{0.28}Cu_{1.84}[Fe(CN)₆]·7.05H₂O. The theoretical capacity was 57.4 mAh/g.

### Preparation of CuPBA Dispersion Liquid

To 0.10 g of the obtained CuPBA powder, 5 mL of an aqueous solution of 0.052 g (1.23×10⁻⁴ mol) of 20.1 mol % of potassium hexacyanoferrate(II) trihydrate of the total metal amount of CuPBA was added as a dispersant, and the mixture was stirred for 2 weeks to obtain a potassium-containing CuPBA dispersion liquid. The resulting potassium-containing CuPBA had a composition of K_{0.58}Cu_{1.69}[Fe(CN)₆]·6.47H₂O and a theoretical capacity of 58.4 mAh/g. The obtained potassium-containing CuPBA has a structure in which ferrocyanide ion is coordinated to a metal located on the surface of CuPBA.

### Preparation of CuPBA Binder-Free Electrode

The obtained CuPBA dispersion liquid and a single-walled carbon nanotube (SWNT) dispersion liquid (0.4 wt %, KJ Special Paper Co., Ltd., TB004M) were mixed in an amount such that the SWNT content was 2.7 wt % and the CuPBA loading amount was 0.5 mg/cm² to obtain a mixed liquid.

The resulting mixed liquid was filtered by suction onto a PTFE membrane filter (pore size: 0.1 μm, HPW-010-30, Sumitomo Electric Industries, Ltd.) and heated at 120 C to obtain a CuPBA binder-free electrode.

### Preparation of Negative Electrode

A Zn foil (0.1 mm thick, Takeuchi Metal Foil & Powder Co., Ltd., 99.99%) polished with water-resistant abrasive paper (Sankyo Rikagaku, #1500) was used as the negative electrode.

### Preparation of Electrolytic Solution

An electrolyte was prepared by dissolving 2M K(OTf) and 1M Zn(OTf)₂ as electrolytes in a mixed solution of propylene carbonate and distilled water (volume ratio 9:1) as solvents.

### Production of Secondary Battery

Using the prepared CuPBA binder-free electrode as the positive electrode, the prepared negative electrode, the prepared electrolyte solution, the PTFE membrane filter used for the filtration formation of the electrode as the separator, and carbon paper (Mitsubishi Chemical Corporation, MFO) as the current collector, an ion secondary battery was prepared in which intercalation and deintercalation of K⁺ in the positive electrode and dissolution/deposition of Zn²⁺ in the negative electrode served as driving forces. FIG. 2 is a schematic diagram of the configuration of the secondary battery.

### Comparative Example 6

### Preparation of CuPBA Suspension

To 0.100 g of CuPBA powder obtained in the same manner as in Example 24, 5.0 mL of distilled water was added, and the mixture was treated with a sonicator (ASONE, MCD-2P) for 1 hour to obtain a CuPBA suspension.

### Preparation of CuPBA Binder-Free Electrode

The obtained CuPBA suspension was mixed with a single-walled carbon nanotube (SWNT) dispersion liquid (0.4 wt %, KJ Special Paper Co., Ltd., TB004M) in an amount such that the SWNT content was 2.7 wt % and the CuPBA loading amount was 0.5 mg/cm², thereby obtaining a mixed liquid.

The resulting mixed liquid was filtered by suction onto a PTFE membrane filter (pore size: 0.1 μm, HPW-010-30, Sumitomo Electric Industries, Ltd.) and heated at 120 C to obtain a CuPBA binder-free electrode. The obtained electrode was used to produce a secondary battery in the same manner as in Example 24.

### (Comparative Example 7) Preparation of CuPBA Binder-Containing Electrode and Battery Characteristics

### Preparation of Binder-Containing Electrode

21.1 mg of CuPBA powder obtained in the same manner as in Example 24, 3.0 mg of polyvinylidene fluoride (PVDF, SigmaAldrich, weight-average molecular weight Mw approximately 523,000), 6.0 mg of SuperP (MTI corporation) as particulate conductive carbon particles, and 200 μL of 1-methyl-2-pyrrolidone (SigmaAldrich) were mixed and mixed for 4 hours using an automated mortar (AMM-140D, Nitto Kagaku Co., Ltd.) to obtain a paste. The mass ratio of CuPBA:SuperP:PVDF was 7:2:1. The obtained paste was applied to carbon paper and dried by heating (120° C. for 1 hour) to prepare a binder-containing CuPBA electrode. The loading amount of CuPBA was 0.5 mg/cm². The obtained electrode was used to produce a secondary battery in the same manner as in Example 24.

The battery characteristics of the secondary batteries produced in Example 24 and Comparative Examples 6 and 7 were evaluated using a potentiostat/galvanostat analyzer ECstat-302 manufactured by EC Frontier Co., Ltd. as the charge and discharge device and SB9 manufactured by EC Frontier Co., Ltd. as the charge and discharge evaluation cell.

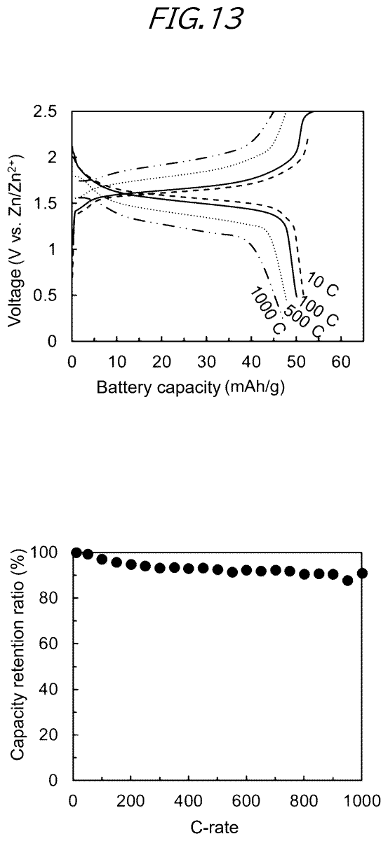

FIG. 13 shows the charge-discharge curve and C-rate characteristics of the secondary battery including the CuPBA binder-free electrode. For the C-rate characteristics, the capacity of 1 C was taken as 100%. The produced battery showed a capacity of 51.7 mAh/g at 0.5 C, which was 88.5% of the theoretical capacity (58.4 mAh/g). The capacity decreased gradually with increasing C-rate, but the capacity was 85% or more of that at 0.5 C even at 1000 C. The produced battery also clearly showed a plateau region with a slope of −0.0051 at 100 C.

Table 5 shows the production conditions of the secondary battery including the amount of dispersant, the amount of SWNTs, the loading amount of active material, and the electrolyte concentration as well as the ratio of the number of primary particles, the energy density (Wh/kg) when the power density is 10000 (W/kg), and the capacity retention ratio (%) when the energy density of 60 Wh/kg or more and the power density of 10000 W/kg are obtained, in Example 24 and Comparative Examples 6 and 7. For the column of energy density (Wh/kg) when the power density was 30000 W/kg, those for which the power density did not reach 30000 W/kg are indicated as [-]. For the column of the capacity retention ratio (%) when obtaining the energy density of 60 Wh/kg or more and the power density of 10000 W/kg or more, [-] is displayed when the capacity retention ratio is less than 60%.

TABLE 5
Production conditions, composition, and characteristics of secondary
batteries in Example 24 and Comparative Examples 6-7

| | | | | | | | Capacity |
|---|---|---|---|---|---|---|---|
| | | | | | | | Retention (%) |
| | | | | | | Energy Density | When Achieving |
| | | | Active | | Primary | at Power | Energy Density ≥60 |
| | Dispersant | SWNT | Material | Electrolyte | Particle | Density of | Wh/kg and Power |
| | Amount | Amount | Loading | Concentration | Ratio | 30,000 W/kg | Density ≥10,000 |
| | (mol %) | (wt %) | (mg/cm²) | (mol/L) | (%) | (Wh/kg) | W/kg |
| Example 24 | 20.1 | 2.7 | 0.5 | K(OTf):2M | 81 | 67 | 87 |
| | | | | Zn(OTf)₂:1M | | | |
| | | | | PC:water = 9:1 | | | |
| Comparative | 0 | 2.7 | 0.5 | K(OTf):1M | 34 | — | — |
| Example 6 | | | | Zn(OTf)₂:1M | | | |
| (Suspension) | | | | PC:water = 9:1 | | | |
| Comparative | 0 | Super P | 0.5 | K(OTf):1M | 17 | — | — |
| Example 7 | | | | Zn(OTf)₂:1M | | | |
| (with Binder) | | | | PC:water = 9:1 | | | |

Comparison with Ragone Plot

FIG. 17 is a Ragone plot showing the relationship between the energy density (capacity) and the power (output) density of the secondary batteries produced in Examples 5, 18, 19, 22, and 24 and Comparative Examples 2 to 7. In addition to the above Comparative Examples, a half-cell described in Non-Patent Literature 9 in which ZnPBA is used as an active material is shown in the Ragone plot. The half cell described in Non-Patent Literature 11 in which MnPBA is used as an active material and the half cell described in Non-Patent Literature 10 in which CuPBA is used as an active material are shown in the Ragone plot using the voltage converted based on the Zn/Zn²⁺ reference. For reference, the energy density (capacitance) and power (output) density regions of conventional capacitors (Capacitors), supercapacitors (Supercapacitors), ion-secondary batteries (Batteries), and fuel-cells (Fuel cells) are also shown.

As the capacity and voltage generally decrease with increasing C-rate, the Ragone plot becomes a sloped plot to the upper left. If the capacity and the voltage do not decrease even when the C-rate is increased, the Ragone plot is plotted directly above.

In the conventional ion secondary batteries, the energy density decreases at 10 C (10¹ C), which is due to a decrease in capacity and a decrease in voltage caused by the effect of internal ion diffusion or the like. On the other hand, the secondary batteries produced in Examples 18, 22, and 24 had a small capacity up to 100 C (10² C), were able to suppress a capacity decrease even up to 1000 C (10³ C) which was one order of magnitude higher, and were able to achieve both high energy density and high-speed charge and discharge performance compared to conventional batteries.

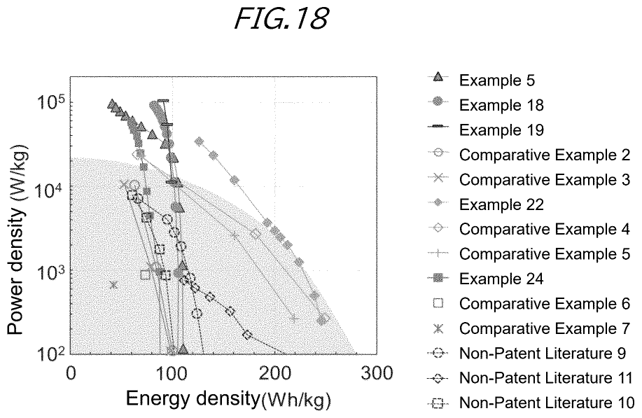

FIG. 18 is a Ragone plot showing the relationship between the energy density (capacity) and the power (output) density for the secondary batteries produced in Examples 5, 18, 19, 22, and 24 and Comparative Examples 2 to 7 using the horizontal axis as the real number display. The secondary batteries produced in the Comparative Examples had a large decrease in energy density before the power density reached 10000 W/kg, but the secondary batteries produced in the Examples had a power density of 30000 W/kg or more and exhibited an energy density of 60 Wh/kg or more.

The secondary batteries produced in Examples 5, 18, 19, and 24 had a capacity retention ratio of 80% or more with respect to capacity at 1 C when obtaining an energy density of 60 Wh/kg or more and a power density of 10000 W/kg or more.

The secondary battery produced in Example 22 had a capacity retention ratio of 60% or more with respect to capacity at 1 C when obtaining an energy density of more than 100 Wh/kg and a power density of 10000 W/kg or more.

1. An electrode for a secondary battery, comprising
carbon nanotubes, and
active material particles having an average particle size of 2 to 1000 nm supported in a state of being dispersed in the carbon nanotubes,
wherein a mass ratio of the carbon nanotubes to a total mass of the active material particles and the carbon nanotubes is 0.1 wt % or more, and
the active material particles have a positive or negative surface charge, or are surface-modified with organic compounds having an alkyl chain.

2. The electrode according to claim 1, wherein a ratio of a number of primary particles to a number of all particles of the active material particles is 70% or more.

3. The electrode according to claim 1, wherein the electrode does not comprise a binder.

4. The electrode according to claim 1, wherein the active material is Prussian blue or an analog thereof.

5. The electrode according to claim 4, wherein the Prussian blue or an analog thereof is Fe—Zn Prussian blue or an analog thereof, Fe—Mn Prussian blue or an analog thereof, or Fe—Cu Prussian blue or an analog thereof.

6. A secondary battery comprising the electrode according to claim 1, a counter electrode, an electrolyte solution, and a current collector.

7. The secondary battery according to claim 6, wherein the concentration of the electrolyte solution is 0.8 M or more.

8. The secondary battery according to claim 6, wherein the current collector is carbon paper.

9. The secondary battery according to claim 6, wherein the secondary battery has an energy density of 60 Wh/kg or more and a power density of 30000 W/kg or more.

10. The secondary battery according to claim 6, wherein a capacity retention ratio with respect to a capacity at 1 C when an energy density of 60 Wh/kg or more and a power density of 10000 W/kg or more are obtained is 80% or more.

11. The secondary battery according to claim 6, wherein a capacity retention ratio with respect to a capacity at 1 C when an energy density of more than 100 Wh/kg and a power density of 10000 W/kg or more are obtained is 60% or more.

12. A method for producing an electrode for a secondary battery, comprising:
surface-modifying active material particles having an average particle size of 2 to 1000 nm to prepare a dispersion liquid of the active material particles in which the surface-modified active material particles are dispersed;
preparing a dispersion liquid of carbon nanotubes;
mixing the dispersion liquid of the active material particles and the dispersion liquid of the carbon nanotubes so that a mass ratio of the carbon nanotubes to a total mass of the active material particles and the carbon nanotubes is 0.1 wt % or more to form a mixed liquid; and
applying the mixed liquid onto a substrate to obtain an electrode film.

13. The method for producing an electrode for a secondary battery according to claim 12, wherein the applying the mixed liquid onto the substrate to obtain the electrode film comprises filtering the mixed liquid through a filter to obtain a filtration membrane.

14. The method according to claim 12, wherein the filter is a polytetrafluoroethylene membrane.

15. A secondary battery comprising the electrode according to claim 2, a counter electrode, an electrolyte solution, and a current collector.

16. A secondary battery comprising the electrode according to claim 3, a counter electrode, an electrolyte solution, and a current collector.

17. A secondary battery comprising the electrode according to claim 4, a counter electrode, an electrolyte solution, and a current collector.

18. A secondary battery comprising the electrode according to claim 5, a counter electrode, an electrolyte solution, and a current collector.

19. The method according to claim 13, wherein the filter is a polytetrafluoroethylene membrane.
